(19) United States
(12) Patent Application Publication
(10) Pub. No.: US 2011/0079562 A1
(43) Pub. Date: Apr. 7, 2011

(54) LIQUID SEPARATION USING RELATIVE MOTION AND FLUID EFFECTS

(76) Inventor: James Alexander Stark, South Pasadena, CA (US)

(21) Appl. No.: 12/896,560

(22) Filed: Oct. 1, 2010

Related U.S. Application Data
(60) Provisional application No. 61/248,076, filed on Oct. 2, 2009.

(51) Int. Cl. B01D 35/00

(52) U.S. Cl. 210/791; 210/416.1; 210/808; 210/412

(57) ABSTRACT

The embodiments disclosed herein are generally directed to the separation of mixtures of liquids and solids, of liquids and liquids, and/or liquids and solute using a separation medium. The separation medium can be a membrane with a small pore size or a fine mesh. In some embodiments the properties of interactions between the liquid and the medium and/or between components of the mixture are of significance.

### CROSS-REFERENCE TO RELATED APPLICATIONS

This application claims the benefit of U.S. Provisional Application No. 61/248,076, titled “LIQUID SEPARATION USING RELATIVE MOTION AND FLUID EFFECTS” and filed Oct. 2, 2009. This application is hereby incorporated by reference in its entirety.

### BACKGROUND

1. Field

Disclosed herein are systems, devices, and methods related to the separation of mixtures of liquids and solids, of liquids and liquids, and liquids and solutes.

2. Description of the Related Art

A common filtration setup involves a filter barrier with a mixture on one side and the separated liquid on the other side. Often, a pump is applied to the mixture to force the liquid through the filter barrier. This presents a variety of engineering challenges, build costs and production costs.

Separation technologies are used in many liquid-solid applications. Examples can include: purification and residue removal in chemical production, where the desired product is the purified liquid; solvent removal in pharmaceuticals, where the product is the solid; paper making; sewage treatment, where removal of solids reduces subsequent treatment cost. There are increasingly important applications in liquid-liquid applications, with the development of specialized membranes sometimes using nanotechnology. Examples can include: desalination, energy, and/or fuel cells.

### SUMMARY

Some embodiments herein are directed to a system for liquid separation that can include a separation medium adapted to separate a liquid from a mixture, the separation medium having a first surface and a second surface, wherein the second surface is opposite the first surface and the second surface is adapted to contact the mixture; and a first moving element having an outer surface, wherein: at least a portion of the outer surface is movable relative to the separation medium, the first moving element is adapted to urge the liquid through the separation medium from the second surface to the first surface, and the outer surface of the first moving element is located in contact with or substantially adjacent to the first surface relative to the second surface.

Some embodiments herein are directed to a system for liquid desalination that can include a separation medium adapted to separate an at least partially enclosed space into a first chamber and a second chamber, wherein the second chamber is adapted to receive salt water; and a first moving element positioned in the first chamber and in contact with or substantially adjacent to the separation medium, wherein the first moving element is adapted to pull water molecules through the separation medium from the second chamber into the first chamber via one or more of surface tension, hydrodynamic, and hydrostatic forces.

Some embodiments herein are directed to a system for water treatment that can include a separation medium adapted to separate a first chamber from a second chamber, wherein the first chamber is adapted to receive a non-potable mixture comprising a liquid; and a first moving element positioned in the first chamber and in contact with or substantially adjacent to the separation medium, wherein the first moving element is adapted to pull the liquid through the separation medium from the second chamber into the first chamber via surface tension, hydrodynamic, or hydrostatic forces.

Some embodiments herein are directed to a method for liquid separation that can include moving at least a portion of an outer surface of a first moving element into contact with or substantially adjacent to a first surface of a separation medium, the separation medium further comprising a second surface opposite the first surface, the second surface in contact with a mixture comprising a liquid, wherein the movement urges a first amount of liquid to move through the separation medium from the second surface to the first surface to contact the outer surface of the first moving element; and moving the portion of the outer surface of the first moving element away from the first surface to cause the first amount of liquid to be removed from the separation medium.

Some embodiments herein are directed to a method for liquid separation that can include applying at least a portion of an outer surface of a first moving element to a first surface of a separation medium to contact or be substantially adjacent to the separation medium, wherein the separation medium further comprises a second surface opposite the first surface that is in contact with a mixture comprising a liquid; and generating fluid forces between the outer surface of the first moving element and the first surface of the separation medium to pull the liquid through the separation medium from the second surface to the first surface.

Some embodiments herein are directed to a method for liquid separation that can include providing a system for liquid separation comprising an at least partially enclosed space, a separation medium, and a first moving element, wherein the at least partially enclosed space is divided into a first chamber and a second chamber by the separation medium and the first moving element is located in the first chamber and is in contact with or substantially adjacent to the separation medium; introducing a mixture comprising liquid into the second chamber; and moving the first moving element to generate one or more of surface tension, hydrodynamic, and hydrostatic forces to pull the liquid through the separation medium from the second chamber into the first chamber.

Some embodiments herein are directed to a method for liquid desalination that can include providing a system for liquid desalination comprising an at least partially enclosed space, a separation medium, and a first moving element, wherein: the at least partially enclosed space is divided into a first chamber and a second chamber by the separation medium, the first moving element is located in the first chamber and is in contact with or substantially adjacent to the separation medium, and the second chamber is adapted to receive a salt water mixture; depositing the salt water mixture into the second chamber; and moving the first moving element to pull at least a portion of the mixture through the separation medium from the second chamber into the first chamber, wherein a salt content of the mixture is reduced when pulling the mixture through the separation medium.

Some embodiments herein are directed to a method for water treatment that can include providing a system for water treatment comprising an at least partially enclosed space, a separation medium, and a first moving element, wherein: the at least partially enclosed space is divided into a first chamber and a second chamber by the separation medium, the first moving element is located in the first chamber and is in contact with or substantially adjacent to the separation medium, and the second chamber is adapted to receive a non-potable mixture comprising a liquid; introducing the non-potable mixture into the second chamber; and moving the first moving element to pull the liquid through the separation medium from the second chamber into the first chamber, wherein the liquid is separated from the non-potable mixture upon being pulled through the separation medium.

These and other embodiments are described in further detail below.

### BRIEF DESCRIPTION OF THE DRAWINGS

FIG. 1 is a cross sectional view of one embodiment of a liquid separation system described herein.

FIG. 2 is a schematic illustrating movement of a moving element described herein.

FIG. 3 is a cross sectional view of one embodiment of a liquid separation system described herein.

FIG. 4 is a cross sectional view of one embodiment of a liquid separation system described herein.

FIG. 5A is a cross sectional view of one embodiment of a liquid separation system utilizing perpendicular movement as described herein.

FIG. 5B is a cross sectional view of the liquid separation system of FIG. 5A.

FIG. 6 is a cross sectional view of one embodiment of a liquid separation system described herein.

FIG. 7 is a cross sectional view of one embodiment of a liquid separation system described herein.

FIG. 8 is a cross sectional view of one embodiment of a liquid separation system described herein.

FIG. 9 is a cross sectional view of one embodiment of a liquid separation system described herein.

FIG. 10 is a cross sectional view of one embodiment of a liquid separation system described herein.

FIG. 11 is a schematic illustrating one embodiment of a liquid separation system that can include a plurality of separation media as described herein.

FIG. 12 is a cross sectional view of one embodiment of a liquid separation system described herein.

FIG. 13 is a cross sectional view of one embodiment of a liquid separation system described herein.

FIG. 14 is a cross sectional view of one embodiment of a liquid separation system described herein.

FIG. 15 is a schematic illustrating one embodiment of frustoconical first and second moving elements described herein.

FIG. 16 is a perspective view of an annular embodiment of a liquid separation system described herein.

FIG. 17 is a cross sectional view of an annular embodiment of a liquid separation system described herein.

FIG. 18 is a cross sectional view of an annular embodiment of a liquid separation system described herein.

FIG. 19 is a cross sectional view of one embodiment of a reciprocating liquid separation system described herein.

FIG. 20 is a cross sectional view of one embodiment of a continuous liquid separation system described herein.

FIG. 21 is a schematic illustrating one embodiment of a liquid separation system described herein.

FIG. 22 is a side view of one embodiment of a liquid separation system described herein.

FIG. 23 is a side view of one embodiment of a first moving element and a removal element as described herein.

FIG. 24 is a cross sectional view of one embodiment of a liquid separation system described herein.

FIG. 25 is a cross sectional view of one embodiment of a liquid separation system described herein.

FIG. 26 is a side view of one embodiment of a moving element and a removal element described herein.

FIG. 27A-B are cross sectional side views of bottom fill embodiments of a liquid separation system described herein.

FIG. 28 is an end view of a bottom fill embodiment similar to that shown in FIG. 27A.

FIG. 29 is a block diagram depicting one embodiment of a computer hardware system configured to run software for implementing one or more embodiments of the liquid separation systems and methods described herein.

FIG. 30 is a system diagram depicting a high level overview of one embodiment of a liquid separation module configured for implementing one or more embodiments of the systems and methods described herein.

### DETAILED DESCRIPTION

Disclosed herein are systems and methods for liquid separation (LS). The systems and methods described herein use different principles of physics, different mechanisms, and engineering designs requiring less force and/or energy to reduce costs relative to conventional liquid separation systems. Advantages can be achieved, for example, by eliminating the need to increase pressure on one side of the filter. The improved liquid separation systems and methods can be applied to a variety of different separation technologies in a variety of different fields, including saltwater separation technologies and sewage treatments, as discussed below.

With some conventional liquid separation systems, a motor coupled to a pump is used to create significant pressure differentials, thereby forcing liquid through a filter to separate the liquid from a mixture. Generally, such systems require powerful motors to create the necessary pressure differential for moving the liquid through the filter. When applying such significant pressure differentials, particles in the mixture can be trapped in the filter, thereby requiring additional pressure to force the liquid through the filter, which can create inefficiencies in the system. It would be advantageous to utilize a system that does not rely on significant pressure differentials to move liquid through a filter, thereby allowing the use of a less powerful motor to create a more efficient system.

To achieve the foregoing, the liquid separation systems disclosed herein allow for separating liquid by using fluid effects in combination with mechanical forces generated by a motor. For example, the liquid separation system illustrated herein can comprise a separation medium, separating two areas. A liquid mixture can be located in one of the areas. The liquid separation systems can also comprise a moving element (for example, a roller, paddle element, or wing element) that contacts or is in close proximity to the separation medium to draw or urge liquid from the first area into the second area by moving the liquid through the separation medium. To draw the liquid across the separation medium, the moving element is put into motion relative to the separation medium using a motor, which can be a low power motor. The movement of the moving element relative to the separation medium in part generates fluid effects, for example, hydrodynamic forces, that urge the liquid to move through the separation medium, thereby separating the liquid from the mixture. In an embodiment, the moving element comprises a hydrophilic surface or material that can also urge the fluid to move through the separate medium. Through the use of fluid effects, the systems and methods disclosed herein can operate or be performed more energy efficiently as compared to other liquid separation systems.

Prior to separation, the liquid can be part of a mixture. The term “mixture” is used herein according to its ordinary meaning as known to those skilled in the art and refers to combinations of two or more substituent chemical substances, and includes, for example, solutions, suspensions, slurries, and emulsions. Liquid separation can include, for example, the separation of mixtures of liquids and solids, liquids and liquids, liquids and gases, and liquids and solutes. Examples of mixtures include, but are not limited to, salt water (e.g., seawater) and sewage.

The term “residue” is used herein according to its ordinary meaning and refers to any part of a mixture that does not pass through a separation medium. The term “filtrate” is also used herein according to its ordinary meaning and refers to any part of a mixture that does pass through a separation medium. In some embodiments, the residue can include a solid and the filtrate can include a liquid. In other embodiments, both the residue and the solid can include a liquid. In yet other embodiments, the residue and/or filtrate can include both solid and liquid components. In some cases, a primary intent is to remove residue. In other cases, a primary intent is to remove filtrate. Advantageously, the residue and/or filtrate can include different proportions of the components as compared to the original mixture.

In some embodiments, the mixture can include at least one liquid component and at least one solid component. Solid-liquid separation (SLS) can involve taking liquids containing solids (for example, a slurry) and separating into a filtrate (for example, a liquid with smaller proportion of solids) and residue (for example, a solid with less water). In certain embodiments, the objective can be purification of a liquid, but in other embodiments, a reduction in solids can be required. In certain embodiments, the primary interest is in the solids, and the overall purpose can be to wash and/or extract the solid material. Those of ordinary skill in the art may appreciate that although many examples herein may be directed to SLS, the systems and methods disclosed herein may be applicable to all types of liquid separation.

There are familiar situations where one separates solids and liquids. One example is filtering glaze in a pottery class. In the kitchen, one might put fruit juice in a separation medium (e.g., a sieve) to remove some of the pulp. After gravity has done its work, the normal thing is to apply pressure to the residue to push remaining juice through the sieve. However, one might also notice that pressing one's hand against the underside of the sieve and pulling it away can draw juice through the sieve.

In some cases gravity may be sufficient to drive a liquid through a sieve. In other cases, gravity alone may be insufficient to drive the liquid through the sieve. In many cases the efficiency of the filtration is reduced when residue builds up near, on, or in the separation medium. Energy may be required to pull material through a sieve. In some processes, the pressure difference across the medium may be elevated, either by reducing the pressure on the filtrate side or increasing the pressure on the mixture side. One example is a piston or plunger that may be used in a manual-press coffee maker.

In some processes may involve a sequence of stages, including (1) feeding the mixture onto the medium, (2) driving filtrate through the medium, (3) adding fresh wash water to the residue, (4) further driving of filtrate through the medium, (5) removing the residue (often in the form of a cake and often by blowing), and/or (6) backwash cleaning of the medium by driving liquid or gas through the medium in the reverse direction of filtrate flow. Some other systems also operate cyclically. For example, some systems may rely on a plunger or piston to increase pressure on the mixture side of the system. It is sometimes necessary to operate such a system in a cycle, since the plunger or piston may need to move in opposite directions and the plunger or piston can block access to the mixture/residue side of the separation medium. These cyclical systems may thus rely on complicated implementation designs, and can result in a limited amount of time that the systems are actually filtering material. Furthermore, cyclical systems that rely on a pump or vacuum can be inefficient because they can require the pressure differential to be generated each time the cycle is restarted. Other pump-based designs can also be inefficient because the work output is relatively small compared to the work input. In addition, using a system that applies pressure or creates a vacuum can add more requirements to the system design, thereby requiring additional components, as well as increased structural strength and energy input. Compared to these conventional systems and methods, the improved systems and methods for liquid separation described herein can be more easily performed, provide greater energy-efficiency and are more environmentally-friendly.

### I. Systems for Liquid Separation

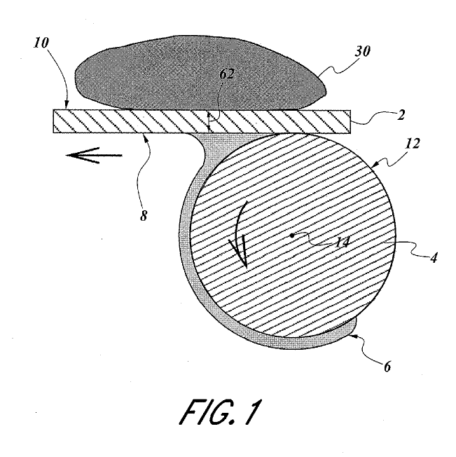

Some embodiments herein are directed to a system for liquid separation that can include a separation medium 2 and a first moving element 4, as shown in FIG. 1.

A. The Separation Medium

The separation medium 2 can be adapted to separate a liquid 6 from a mixture 30. The separation medium 2 can include a first surface 8 and a second surface 10, wherein the second surface 10 is opposite the first surface 8. As shown in FIG. 1, the mixture 30 can be placed into contact with the second surface 10. In some embodiments, the separation medium 2 cooperates with the moving element 4 to draw or pull liquid through the separation medium 2.

In some embodiments, the separation medium 2 can be, for example, mesh, a sieve, a filter, a screen, a membrane, and/or a barrier. The separation medium 2 can be made of any suitable material, such as ceramic, glass, cloth, paper, metal, a polymer (e.g., a polyamide, a polyester, a polyalkylene such as polypropylene, or a fluoropolymer such as polytetrafluoroethylene (PTFE)), and/or diatomaceous earth. The particular separation medium 2 can be selected depending on, for example, the characteristics of the mixture and/or the liquid. In some embodiments, the separation medium 2 can include a plurality of materials and/or layers. For example, a separation medium 2 can include a structural layer and a sacrificial layer. In one embodiment, the structural layer can be a filter and the sacrificial layer can be diatomaceous earth. Various separation media may be commercially available.

In some embodiments, the separation medium 2 can be porous. The pore size of the separation medium 2 can vary widely depending on a number of factors, such as the identity of the mixture and liquid that are to be separated. For example, the pore size can be in the millimeter range, micrometer range, or nanometer range. Selection of an appropriate pore size can be accomplished according to information and methods known to those skilled in the art. In some embodiments, the separation medium 2 can have a pore size in the range of from about 0.1 nm to about 100 nm. In other embodiments, the separation medium 2 can have a pore size in the range of from about 0.1 nm to about 50 nm. In yet other embodiments, the separation medium 2 can have a pore size in the range of from about 0.1 nm to about 10 nm. Those skilled in the art may appreciate that separation media 2 having a pore size in the range of from about 0.1 nm to about 100 nm can be adapted for water purification, e.g., saltwater separation or desalination. In some embodiments, the separation medium 2 can have a pore size in the range of from about 50 μm to about 500 μm. In other embodiments, the separation medium 2 can have a pore size in the range of from about 75 μm to about 300 μm. In yet other embodiments, the separation medium 2 can have a pore size in the range of from about 100 μm to about 300 μm. In one embodiment, the separation medium 2 can have a pore size of about 200 μm. Those skilled in the art may appreciate that separation media 2 having a pore size in the range of from about 50 μm to about 500 μm can be adapted for waste water treatment, e.g., partial sewage filtering.

The separation medium 2 can be found, for example, in a container, machine or other system that involves a separation medium. In some embodiments, the separation medium 2 can be adapted to serve as a filter in a saltwater separation system that reduces the salt content of salt water. For example, the separation medium 2 can be a desalination filter. In other embodiments, the separation medium 2 can be adapted to serve as a filter in a treatment system that separates solid particles from a non-potable mixture. In yet other embodiments, the separation medium 2 can be adapted to serve in an alternate treatment system as a filter that separates biological organisms from a non-potable mixture. For example, the separation medium 2 can be a sewage filter. One skilled in the art will realize that these represent only a few technological areas in which the separation medium 2 can be practically applied, and that the separation medium 2 is not to be limited to any one context.

In some embodiments, the separation medium 2 can include a material that affects the forces of intermolecular attraction between the separation medium 2 and the liquid 6. In some embodiments, such a material can enhance and assist in the pulling of material across the separation medium by the drawing element. The separation medium 2 can be hydrophilic, oleophilic/lipophilic, hydrophobic, and/or amphiphilic. In some embodiments, the separation medium 2 is hydrophilic and has an HLB (hydrophilic-lipophilic balance) value in the range of from about 16 to about 20. In some embodiments, the separation medium 2 can include a hydrophilic polyamide polymer, such as nylon 6 or nylon 6, 6. In some embodiments, the separation medium 2 can have a contact angle with water of about 90° or less. In other embodiments, the separation medium 2 can have a contact angle with water of about 70° or less. In yet other embodiments, the separation medium 2 can have a contact angle with water in the range of from about 30° to about 70°. In some embodiments, the separation medium 2 can include a surfactant and/or wetting agent. In other embodiments, the separation medium 2 is lipophilic and has an HLB value in the range of from about 0 to about 3. In some embodiments where the separation medium is hydrophobic, the separation medium 2 can have a contact angle with water that is greater than 90°. In other embodiments, the separation medium 2 can carry an electrostatic charge. For example, the separation medium 2 can include one or more ionic materials, such as an anionic, cationic, or zwitterionic material.

In other embodiments the separation medium 2 can include a coating that includes one or more substances such as a polymer, oil, or wax. The coating can be hydrophilic, oleophilic/lipophilic, hydrophobic, and/or amphiphilic, and can help to enhance the desired properties of the separation medium. In some embodiments, the coating is hydrophilic and has an HLB (hydrophilic-lipophilic balance) value in the range of from about 16 to about 20. In other embodiments, the coating is lipophilic and has an HLB value in the range of from about 0 to about 3. For example, a hydrophilic polyamide separation medium 2 can be coated with a hydrophobic coating. In some embodiments, the coating can include a surfactant and/or wetting agent. Those skilled in the art may appreciate that the coating can be selected based upon the properties of the liquid to be separated. For example, a hydrophilic coating may be selected when the liquid to be separated is also hydrophilic, such as water. In other embodiments, the coating can carry an electrostatic charge. For example, the coating can include one or more ionic materials, such as an anionic, cationic, or zwitterionic material.

The first surface 8 and the second surface 10 of the separation medium 2 can be separated by a distance defining the thickness 62 of the separation medium 2, as shown in FIG. 1. The thickness 62 of the separation medium 2 can vary. In some embodiments where the separation medium 2 is porous, the separation medium 2 can have a thickness relative to the pore size in the range of from about 0.1 to about 3.0. In some embodiments, the separation medium 2 can have a thickness relative to the pore size in the range of from about 0.5 to about 2.0. For example, a porous separation medium 2 can have a thickness of about 2.0 times the size of the pores. In some embodiments, the thickness 62 of the separation medium 2 can be relatively small as compared to separation media in other liquid separation systems. One advantage of a relatively thin separation medium 2 is that it can utilized reduced and/or simplified structural support.

In some embodiments where the separation medium 2 includes a mesh, the size of the mesh can vary. For example, in some embodiments the mesh can range from about size 10 to about size 200, based upon applicable ASTM standards. In some embodiments, the thickness 62 of the separation medium 2 can vary according to the dimensions of the mesh. For example, the separation medium 2 can have a thickness relative to mesh size (e.g., wire diameter) in the range of from about 0.1 to about 3.0. In some embodiments, the separation medium 2 can have a thickness relative to mesh size (e.g., thread diameter) in the range of from about 1.0 to about 2.5. In yet other embodiments, the separation medium 2 can have a thickness relative to mesh size (e.g., thread diameter) in the range of from about 1.0 to about 3.0. For example, a mesh separation medium 2 can have a thickness of about 2.0 times the diameter of a mesh thread.

In some embodiments, the separation medium 2 can have a thickness 62 in the range of from about 100 μm to about 200 μm. In other embodiments, the separation medium 2 can have a thickness 62 in the range of from about 50 μm to about 150 μm. In yet other embodiments, the separation medium 2 can have a thickness 62 in the range of from about 100 μm to about 300 μm. In one embodiment, thickness 62 can be about 150 μm.

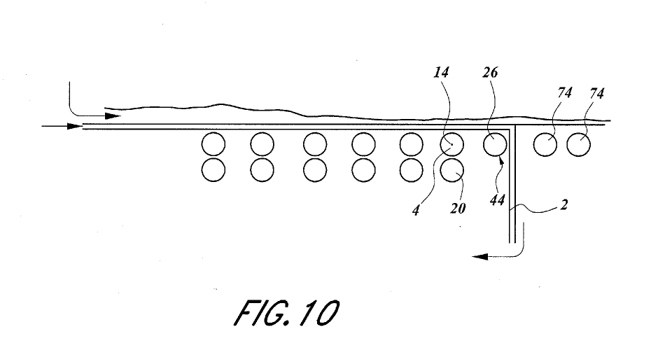

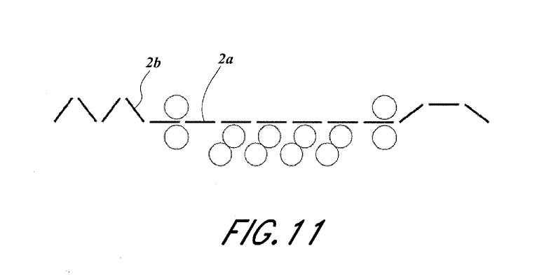

The separation medium 2 can be rigid or flexible. As shown in FIG. 10, the separation medium 2 can be flexible (e.g., cloth). In some embodiments, the separation medium 2 can be a combination of two or more materials, such that the separation medium 2 can be rigid in some areas, while flexible in others. In some embodiments, a flexible separation medium 2 is held in place using a rigid frame. In some embodiments, the system can include a single separation medium 2. As shown in FIG. 11, the separation medium 2 can combine a plurality of separation media 2a, 2b, and the like. Advantageously, as shown in FIG. 11, a plurality of generally rigid separation media 2a, 2b can be combined to make a separation medium 2 having an overall non-planar surface. The individual pieces 2a, 2b can advantageously be joined together.

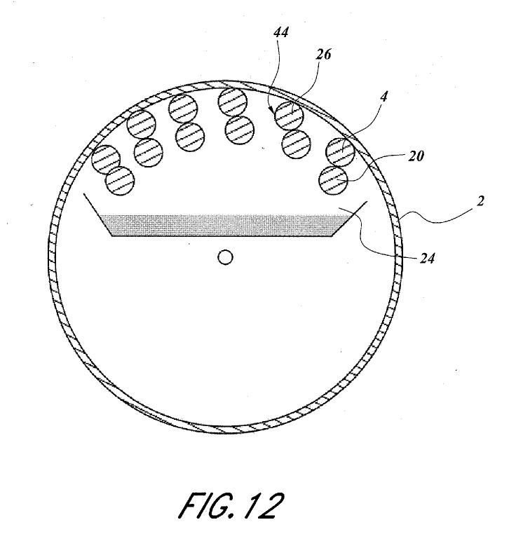

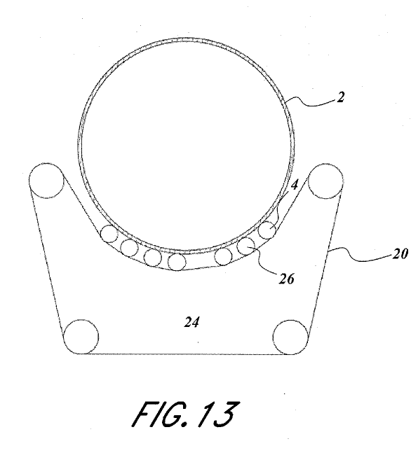

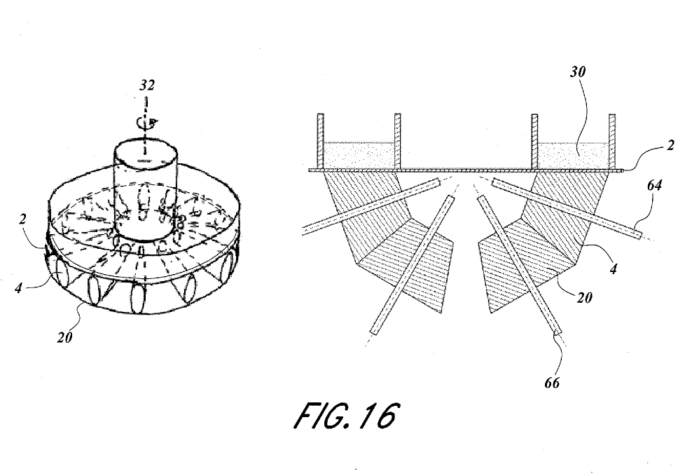

The separation medium 2 can also take on a variety of shapes. For example, the separation medium 2 can be generally planar or flat, as shown in FIGS. 1-9. In other embodiments, the separation medium 2 can be non-planar. As shown in FIGS. 12-13, the separation medium 2 can be generally cylindrical. Advantageously, a cylindrical separation medium may be adapted for a continuous process, such that the separation medium can be continuously recycled, as described further herein. As shown in FIGS. 16-18, the separation medium 2 can be in the shape of a generally planar disk or annulus. When the separation medium 2 is in the shape of a disk or annulus, it can be generally circular. The disk-shaped or annular separation medium 2 can also have a circular aperture in the center of the circle. In one embodiment, the separation medium can be a flat filter with pores. Advantageously, in some embodiments the separation medium can be removable and replaceable from within a liquid separation system. For example, as described herein with respect to FIG. 16, the system can include a separation medium that is adapted as a replaceable cartridge. In a batch process, the cartridge can be replaced whenever a new separation medium is needed or desired.

The separation medium can be adapted for relative translational and/or rotational movement with respect to the first moving element 4, described herein. For example, as shown in FIG. 16, separation medium 2 can be adapted for rotational movement about separation medium axis 32. Another example of relative translational movement of the separation medium 2 is shown in FIG. 10, wherein the separation medium 2 can translate in the direction indicated by the arrows. In other embodiments, the separation medium 2 can be static.

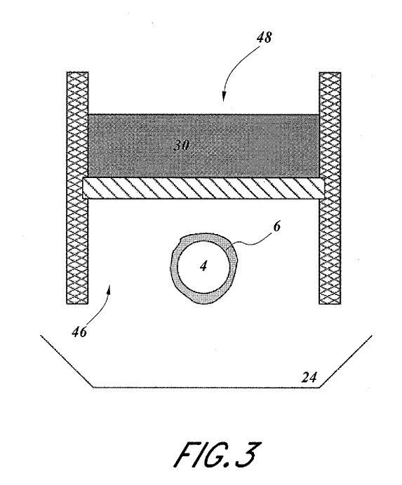

In some embodiments, a system can include an at least partially enclosed space that is divided into a first chamber 46 and a second chamber 48 by the separation medium 2, as shown in FIG. 3. For example, the separation medium 2 can be enclosed within a container that is used for liquid separation (e.g., for producing potable water).

B. The First Moving Element

As shown in FIG. 1, the systems described herein can include a first moving element 4 including an outer surface 12. Within the outer surface 12, the inner surface of the moving element 4 can be solid or hollow. The first moving element 4 can assume a number of different forms (e.g., as a cylindrical roller) and can be configured for rotational and/or translational movement. At least a portion of the outer surface 12 can be movable relative to the separation medium 2. The first moving element 4 can be configured and/or adapted to urge the liquid 6 through the separation medium 2 from the second surface 10 to the first surface 8. As shown in FIG. 1, the first moving element 4 can be more proximate to the first surface 8 than the second surface 10. For example, the outer surface 12 of the first moving element 4 can be located in contact with or substantially adjacent to the first surface 8 of the separation medium 2 relative to the second surface 10.

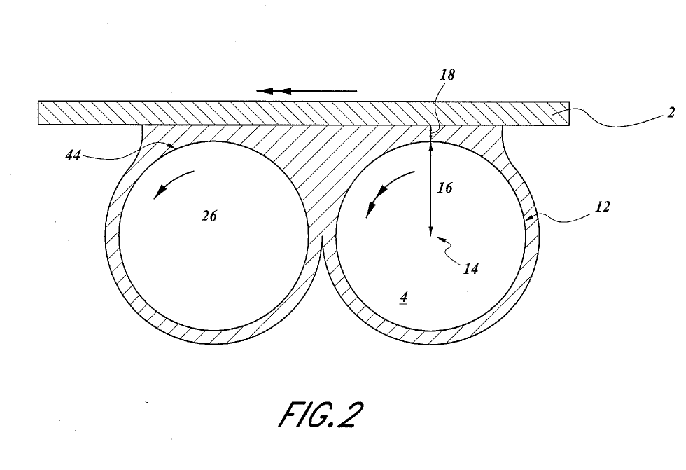

As shown in FIG. 1, the outer surface 12 of the first moving element 4 can contact the first surface 8 of the separation medium 2. As shown in FIG. 2, the first moving element 4 may not contact the separation medium 2. For example, the first moving element 4 can be next to, close to, in proximity to, beside, alongside, and/or substantially adjacent to the separation medium 2. At least a portion of the first moving element 4 can be adapted to be in fluid communication with the first surface 8. For example, the first moving element 4 and the first surface 8 can be separated apart by a distance that allows a continuous stream of liquid 6 to fluidly connect the first moving element 4 to the first surface 8. As shown in FIG. 2, where the first moving element 4 is adapted for rotational movement about a first axis 14, and the first moving element 4 has a radius 16 defined by the distance from the first axis to the outer surface 12 of the first moving element 4, the outer surface 12 of the first moving element 4 can be separated from the separation medium 2 by a distance 18 that is less than the radius of the first moving element 4.

In some embodiments, the distance 18 can vary depending on one or more factors such as the viscosity of mixture 30, the viscosity of liquid 6, the intermolecular attraction between the first moving element 4 and the separation medium 2, and/or the pore size of a porous separation medium 2. In some embodiments where the viscosity of the liquid 6 is relatively low, the distance 18 can be relatively small, for example in the range of from about 0.01 mm to about 0.30 mm, from about 0.02 mm to about 0.30 mm, or from about 0.025 mm to about 0.25 mm. Some examples of relatively low viscosity liquids include, but are not limited to, water and solvents such as some alcohols (e.g., methanol, ethanol, propanol, or isopropyl alcohol), mineral spirits, and dry-cleaning fluids. In some embodiments, relatively low viscosity liquids can have a viscosity at 25° C. in the range of from about 8.5×10⁻⁴ Pa·s to about 1.5×10⁻³ Pa·s. In some embodiments where the viscosity of the liquid 6 is relatively high, the distance 18 can be relatively large, for example in the range of from about 0.5 mm to about 5 mm, from about 0.5 mm to about 3 mm, or from about 1 mm to about 3 mm. Some examples of relatively high viscosity liquids include, but are not limited to heavy oils (e.g., heavy crude oil) and some suspensions. In some embodiments, relatively high viscosity liquids can have a viscosity at 25° C. in the range of from about 2 Pa·s to about 10 Pa·s. In other embodiments where liquid 6 has an intermediate viscosity, the distance 18 can be in an intermediate range, for example from about 0.1 mm to about 2 mm, from about 0.2 mm to about 1.0 mm, or from about 0.1 mm to about 0.8 mm. In some embodiments, the distance 18 is about 3 mm or less. Some examples of intermediate viscosity liquids include, but are not limited to, common oils used for cooking and lubrication. In some embodiments, intermediate viscosity liquids can have a viscosity at 25° C. in the range of from about 0.01 Pa·s to about 1.0 Pa·s.

In some embodiments, the distance 18 can vary with the level of intermolecular attraction between the first moving element 4 and the separation medium 2. For example, in one embodiment, distance 18 can be relatively small when the intermolecular attraction is relatively small. In another embodiment, distance 18 can be relatively large when the intermolecular attraction is relatively large.

In some embodiments, the distance 18 can vary depending on the pore size of a porous separation medium 2. For example, the distance 18 can be relatively small when the pore size is relatively small. In another example, distance 18 can be relatively large when the pore size is relatively large. In some embodiments, the distance 18 can be related to the pore size of separation medium 2 by a factor of about 50, 20, 10, or 5. For example, in one embodiment the distance 18 can be equal to or less than about 10 times the pore size. In another embodiment, the distance 18 can be equal to or less than about 5 times the pore size.

Although not bound by theory, it is believed that movement of the first moving element 4 can generate at least one of surface tension, hydrodynamic, and hydrostatic forces between the moving element 4 and the liquid 6. The term “surface tension” is used herein according to its ordinary meaning and refers to the tendency of an outer surface of a liquid to resist an external force. Surface tension can, for example, be an effect of the uneven distribution of intermolecular forces throughout the liquid. The terms “hydrostatic” and “hydrodynamic” as used herein refer to any dynamic and static fluid and fluid-solid physical phenomena, and are not limited to these properties as exhibited by water. The term “fluid effects” as used herein refers to one or more of hydrodynamic, hydrostatic, surface tension, and intermolecular (e.g., electrostatic) forces.

In certain instances, if one takes a separation medium 2, such as a flat-bottomed sieve, and fills it with an appropriate mixture of liquid and solids, some liquid can pass through the sieve and the sieve pores will begin to be filled with solid particles. By using a moving element 4, as described above, an even greater amount of liquid can pass through the sieve. If a first moving element 4, such as a roller, is run back and forth across the first surface 8 of the sieve, a greater amount of liquid can pass through the sieve and the first moving element 4 can become coated in liquid 6. Fluid effects can pull more liquid 6 through the sieve than would pass solely under the effects of gravity and/or a pressure difference (e.g., increasing pressure adjacent the second surface 10 of the separation medium). In some cases, liquid 6 will fall off, or over and off, the roller, and the rolling action can be sufficient to pull sufficient filtrate through the separation medium 2.

Movement of the first moving element 4 can generate at least one of surface tension, hydrodynamic, and hydrostatic forces between the first moving element 4 and the liquid 6. The speed of movement of the first moving element 4 can vary over a wide range. In some embodiments, the forces generated can be modified by altering the speed (translational or rotational) of the moving element. For example, in some embodiments, increasing the rotational speed of the moving element 4 can affect the forces generated by the moving element 4. Those skilled in the art may appreciate that increasing the speed of rotation can reduce the volume of flow per revolution but can also increase the total number of revolutions for a particular time period. In some embodiments, a relatively low volumetric flow rate may be desired. For example, when the flow rate is reduced, the energy efficiency of the system can increase. In addition, a relatively low volumetric flow rate can reduce the amount of clogging experienced by the separation medium. Those skilled in the art may appreciate that the contribution of various fluid effects can also contribute to the efficiency of the system, for example in comparison to other systems that rely solely upon a pump or vacuum.

In some embodiments, movement of the first moving element 4 can generate a hydrodynamic force suitable for urging liquid 6 through the separation medium 2. For example, in some embodiments where the first moving element 4 is adapted for rotational movement, the first moving element 4 can rotate at a speed faster than about 240 RPM. In other embodiments, the first moving element 4 can rotate at a speed in the range of from about 300 RPM to about 2000 RPM. In yet other embodiments, the first moving element 4 can rotate at a speed in the range of from about 500 RPM to about 2000 RPM. Those skilled in the art may appreciate that a particular rotational speed may be selected depending on a number of factors, such as the diameter of the first moving element 4 (e.g., a cylindrical or frustoconical first moving element 4). In some embodiments, the first moving element 4 can have a diameter in the range of from about 0.5 in to about 3 in and can be adapted to rotate about axis 14 at a speed in the range of from about 500 RPM to about 2000 RPM.

In some embodiments, the system can have at least one configuration wherein the outer surface 12 of the first moving element 4 is separated from the separation medium 2 by a distance such that at least a portion of the outer surface 12 of the first moving element 4, when moved relative to the separation medium 2, is adapted to generate at least one of surface tension, hydrodynamic, and hydrostatic forces between the first moving element 4 and the liquid 6. In one embodiment at least a portion of the outer surface 12 of the first moving element 4 is adapted to generate surface tension between the first moving element 4 and the liquid 6. In another embodiment, at least a portion of the outer surface 12 of the first moving element 4 is adapted to generate hydrodynamic forces between the first moving element 4 and the liquid 6. In yet another embodiment, at least a portion of the outer surface 12 of the first moving element 4 is adapted to generate hydrostatic forces between the first moving element 4 and the liquid 6.

Movement of the first moving element 4 can also reduce the fluid pressure exerted at the first surface relative to the second surface. In some embodiments, the system may have at least one configuration wherein the outer surface 12 of the first moving element 4 is separated from the separation medium 2 by a distance such that at least a portion of the outer surface 12 of the first moving element 4, when moved relative to the separation medium 2, can reduce the fluid pressure exerted at the first surface 8 relative to the second surface 10. For example, when the first moving element 4 is moving, the fluid pressure of the liquid 6 adjacent the first surface 8 may be less than the fluid pressure of the mixture adjacent the second surface 10. In other embodiments, movement of at least a portion of the outer surface 12 of the first moving element 4, when moved relative to the separation medium 2, can reduce the surface tension of the liquid at the first surface 8 of the separation medium 2 relative to the second surface 10.

Movement of the first moving element 4 can also increase the flow of liquid 6 through the separation medium 2 as compared to the flow of the liquid 6 through the separation medium 2 in the absence of the first moving element 4 (e.g., substantially solely in the presence of gravity). In some embodiments, the system may have at least one configuration wherein the outer surface 12 of the first moving element 4 is separated from the separation medium 2 by a distance such that at least a portion of the outer surface 12 of the first moving element 4 is adapted to be in fluid communication with the first surface 8.

As described herein, the motion of the first moving element 4 relative to the separation medium 2 can draw liquid 6 through the separation medium 2. Motion of the separation medium 2 may also or alternatively drive liquid 6 through the separation medium 2. Those skilled in the art may appreciate that the liquid 6 may be removed through a combination of fluid effects and gravity.

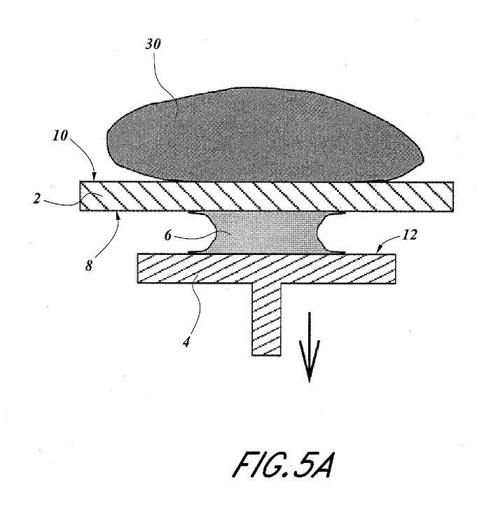

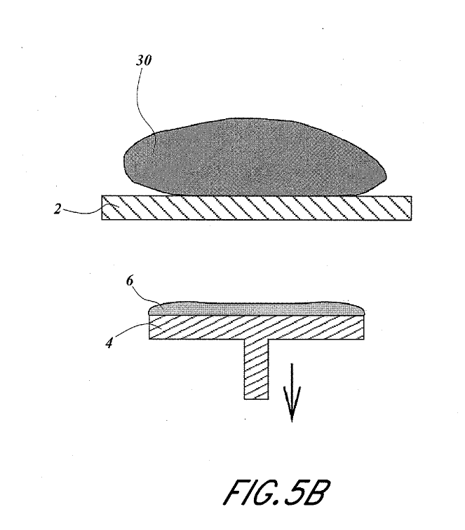

The first moving element 4 can be adapted for a variety of motions and can be configured in a variety of shapes. For example, the first moving element 4 can be adapted for perpendicular (e.g., upward and downward) movement relative to the separation medium 2. In these embodiments, the first moving element 4 can be a paddle, for example, as shown in FIGS. 5A-B. As shown in FIG. 5A, the first moving element 4 can move up to the first surface 8 of the separation medium 2 in a perpendicular motion to become covered in liquid 6. As shown in FIG. 5B, a substantially reciprocating movement of the first moving element 4 relative to the separation medium 2 can pull liquid 6 through the separation medium 2. As shown in FIGS. 5A-B, a moving element adapted for perpendicular movement relative to the separation medium 2 can be a paddle with a surface adapted to contact or be substantially adjacent to the separation medium 2 that is generally planar. In other embodiments, the surface of the first moving element 4 that is adapted to contact or be substantially adjacent to the separation medium 2 can be concave. In these embodiments, the first moving element 4 can act as a suction cup to remove liquid 6 from the first surface 8 of the separation medium 2. In some embodiments, the first moving element 4 can transform from a first form into a second form, thereby provider a greater ability to tailor the separation system to a particular need.

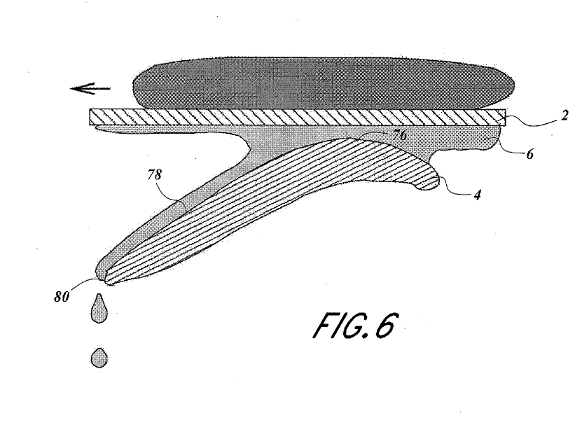

In other embodiments, the first moving element 4 can be adapted for translational (e.g., side to side and/or forward and backward) movement relative to the separation medium 2. In other embodiments, the first moving element 4 can be adapted for a rocking or oscillating motion. In these embodiments, the first moving element 4 can be in the shape of a wing, for example as illustrated in FIG. 6. The wing-shaped first moving element 4 can have an apex 76 (e.g., a curved apex) that is in contact with or is substantially adjacent or proximal to the first surface 8 of the separation medium 2. The apex 76 can advantageously be adapted to attract liquid 6 through the separation medium 2 and onto the first moving element 4. The wing-shaped first moving element 4 can also have an angled surface 78, as illustrated in FIG. 6. In other embodiments, the first moving element 4 can be configured with a angled surface element on either side of the apex 76. The angled surface 78 can be advantageously adapted to urge the liquid 6 away from the separation medium 2, wherein the urging is in part caused by gravitational forces and/or others. As illustrated in FIG. 6, the wing-shaped moving element 4 can also include an end tip 80. Advantageously the end tip 80 can include an edge from which the liquid 6 can drip. Those skilled in the art may appreciate that this design can advantageously and efficiently direct liquid 6 to flow through the separation medium 2 and along first moving element 4 to a removal element 20 or storage element 24, described further herein.

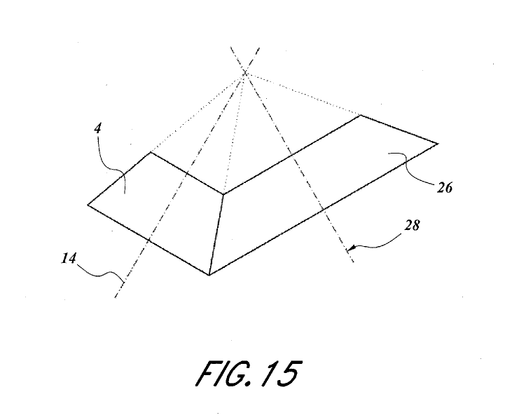

In other embodiments, the first moving element 4 can be adapted for rotational movement about a first axis 14. In these embodiments, the first moving element 4 can be a roller, for example. In some embodiments, the first axis 14 can generally lie parallel to the first surface 8 of the separation medium. For example, in these embodiments the first moving element 4 can be a cylindrical roller, as shown in FIG. 1. The diameter of the cylindrical roller can vary over a wide range and can be selected according to principles known to those skilled in the art, and can be based on one or more properties of the mixture and/or the system components. For example, in some embodiments a cylindrical first moving element 4 can have a diameter in the range of from about 0.1 in to about 10 in. In other embodiments, the cylindrical first moving element 4 can have a diameter in the range of from about 0.5 in to about 3 in. In yet other embodiments, the cylindrical first moving element 4 can have a diameter in the range of from about 0.2 in to about 5 in. In other embodiments, the first moving element 4 can be a roller adapted to rotate about a first axis 14 which lies generally at an angle that is less than 90° relative to the first surface 8 of the separation medium 2 (e.g., 3°, 45°, or 60° relative to the first surface 8 of the separation medium 2). In these embodiments, the first moving element 4 can be a frustoconical roller (e.g., truncated cone shape), for example as shown in FIGS. 15-18. The diameter of a frustoconical roller can also vary over a wide range, and in some embodiments the major diameter of a frustoconical roller can be similar to the diameters described herein with respect to the cylindrical rollers. In some embodiments, the first moving element 4 can be either solid or hollow (e.g., a hollow roller or hollow truncated cone). As shown in FIGS. 16-18, in some embodiments the rotation of the first moving element 4 can be driven by shaft 64. Shaft 64 can be connected to, for example, a motor.

In some embodiments, the motor can be generally energy efficient as compared to motors used in other liquid separation systems. For example, as compared to conventional pumps that require strong motors to create significant pressure differentials, the liquid separation systems described herein can use less powerful motors to perform liquid separation. For example, some conventional pump-based systems can operate at rates of about 50% efficiency or less. Inefficiencies can result from a variety of factors, such as the development of back pressure, which can reduce flow rates. In contrast, the liquid separation systems described herein can advantageously operate substantially more efficiently, for example, 1.3, 1.5, 1.7, or 2.0 times as efficiently as some conventional systems. As described herein, the present systems and methods can require a relatively small amount of energy since the mechanical forces of the motor are supplemented by fluid effects and other forces to perform liquid separation. Consequently, in some embodiments, utilization of the present systems and methods can result in as much as a tenfold reduction in input power (e.g., 90% energy savings) as compared to some conventional systems and methods.

The first moving element 4 can be made from a variety of materials, such as one or more of a metal, polymer (e.g., a silicone or latex polymer), glass, rubber, wood, or ceramic. In one embodiment, at least a portion of the first moving element 4 (e.g., outer surface 12) can include a silicone or latex polymer. In another embodiment, at least a portion of first moving element 4 (e.g., outer surface 12) can include rubber. Those skilled in the art may appreciate that the first moving element 4 can include a plurality of materials and/or layers. For example, the first moving element 4 can include a metal core with a polymeric outer surface 12.

In some embodiments, at least a portion of the first moving element 4 (e.g., outer surface 12) can include a material that affects the forces of intermolecular attraction between the first moving element 4 and the liquid 6. The first moving element 4 (e.g., outer surface 12) can include a material that is hydrophilic, oleophilic/lipophilic, hydrophobic, and/or amphiphilic. In some embodiments, the first moving element 4 can be hydrophilic and can have an HLB (hydrophilic-lipophilic balance) value in the range of from about 16 to about 20. In some embodiments, the first moving element 4 can have a contact angle with water of about 90° or less. In other embodiments, the first moving element 4 can have a contact angle with water of about 70° or less. In yet other embodiments, the first moving element 4 can have a contact angle with water in the range of from about 30° to about 70°. In other embodiments, the first moving element 4 can be lipophilic and can have an HLB value in the range of from about 0 to about 3. In some embodiments where the first moving element 4 is hydrophobic, the first moving element 4 can have a contact angle with water that is greater than 90°. In some embodiments, the first moving element 4 can include a surfactant and/or wetting agent. In yet other embodiments, the first moving element 4 can include a material that has or is adapted to carry/maintain an electrostatic charge, thereby influencing the forces created by the moving element 4. For example, the first moving element 4 can include one or more ionic materials, such as an anionic, cationic, or zwitterionic material.

In other embodiments the first moving element 4 can include a coating on outer surface 12 that includes one or more substances such as a polymer, oil, or wax to enhance the advantageous properties of the moving element 4. The coating can be hydrophilic, oleophilic/lipophilic, hydrophobic, and/or amphiphilic. In some embodiments, the coating is hydrophilic and has an HLB (hydrophilic-lipophilic balance) value in the range of from about 16 to about 20. In other embodiments, the coating is lipophilic and has an HLB value in the range of from about 0 to about 3. In some embodiments, the coating can include a surfactant and/or wetting agent. Those skilled in the art may appreciate that the coating can be selected based upon the properties of the liquid to be separated. For example, a hydrophilic coating may be selected when the liquid to be separated is also hydrophilic, such as water. In yet other embodiments, the first moving element 4 can include a coating that is adapted to carry/maintain an electrostatic charge. For example, the coating can include one or more ionic materials, such as an anionic, cationic, or zwitterionic material.

The outer surface 12 of the first moving element 4 can be rigid or flexible/compliant. Advantageously, a particular level of flexibility/compliance can be selected based on a number of factors, including but not limited to the force necessary to push the first moving element 4 against the separation medium 2 (in embodiments where the first moving element 4 contacts the separation medium 2) and the surface configuration of the first moving element 4. In some embodiments, the first moving element 4 can have a substantially rigid outer surface 12. In other embodiments, the outer surface 12 can be substantially non-porous and/or substantially non-absorbent with respect to liquid 6 and/or mixture 30. In yet other embodiments, the outer surface 12 can be substantially impermeable to water. As described further herein, the outer surface 12 can be non-smooth, which can advantageously assist in pulling the liquid 6 through and/or across the separation medium 2.

In some embodiments, the first moving element 4 can be adapted to have forward and/or backward translational (e.g., sliding) movement relative to the separation medium 2. For example, the separation medium 2 can be adapted to translate forward and/or backward and the first moving element 4 may not be adapted to translate forward and/or backward. In FIG. 16, for example, the separation medium 2 may be adapted to translate relative to the first moving element 4 via rotation around separation medium axis 32. In another example, the first moving element 4 can be adapted to translate forward and/or backward and the separation medium 2 may not be adapted to translate forward and/or backward. In yet another example, the separation medium 2 can be adapted to translate in a first direction (e.g., forward) and the first moving element 2 can be adapted to translate in a second direction that is opposite the first direction (e.g., backward). In some of the embodiments where one or both of the first moving element and the separation medium 2 is adapted for forward and/or backward translational movement, the first moving element 4 can be a roller (e.g., cylindrical or frustoconical) adapted to rotate about an axis that is perpendicular to the direction of relative translational movement. Advantageously, this relative movement can allow the system to operate continuously, as the separation medium 2 can cycle through various stations as described further herein.

As described herein, the first moving element 4 can be adapted for relative movement with respect to the separation medium 2. Accordingly, in some embodiments the first moving element 4 can move (e.g., rotate, translate laterally, and/or translate vertically) and the separation medium 2 may not move. In other embodiments, the separation medium 2 can move and the moving element 4 may not move. In yet other embodiments, both the separation medium 2 and the moving element 4 can move.

In some embodiments, the system can include a plurality of moving elements (e.g., 2, 3, 4, 5, 6, 7, 8, 9, or 10 moving elements). For example, in some embodiments the system can include at least a first moving element 4 and a second moving element 26, as shown in FIG. 10. As shown in FIG. 10, the second moving element 26 can be positioned substantially adjacent to the first moving element 4. The second moving element 26 can have any of the characteristics described herein with respect to the first moving element 4. For example, in some embodiments the second moving element 26 can be in contact with or substantially adjacent to the first surface 8 of the separation medium 2. In some embodiments, the first moving element 4 and the second moving element 26 are each rollers adapted for rotational motion about first and second axes 14, 28, respectively. As shown in FIG. 10, the first axis of rotation 14 of first moving element 4 and the second axis of rotation 28 of second moving element 26 can be generally parallel.

In some embodiments, like the first moving element 4, the additional moving elements can also generate any of the forces described above (e.g., surface tension, hydrodynamic, and hydrostatic forces) to influence the flow of liquid. Alternatively, in some embodiments, the additional moving elements can serve a different function from the first moving element 4. For example, in some embodiments, while a first moving element 4 can generate forces to produce a force that separates liquid material, a second moving element can serve as a scraper to physically remove liquid material from the first moving element 4.

In some embodiments where the moving elements are adapted for rotational motion about an axis, the first and second axes of rotation 14, 28 may not be parallel, for example as shown in FIG. 15. In some embodiments, this may occur when the moving elements are flexible and have instantaneous axes of rotation. In other embodiments, for example as shown in FIG. 15, the first moving element 4 and the second moving element 26 can each be frustoconical. Two right circular cones can rotate continuously if their apexes are at the same point in space. This can also be true of truncated cones, for example as shown in FIG. 15. In some embodiments, the second moving element 26 can be a second roller adapted to rotate about second axis 28 which lies generally at an angle that is less than 90° relative to the first surface 8 of the separation medium 2 (e.g., 30°, 45°, or 60° relative to the first surface 8 of the separation medium 2).

As shown in FIGS. 15-18, in some embodiments the moving elements can include a plurality of frustoconical rollers. Advantageously, the axes of rotation of each of the frustoconical rollers can intersect. Furthermore, the apexes of each frustoconical roller can be collocated.

In some embodiments where the system includes an at least partially enclosed space that is divided into a first chamber 46 and a second chamber 48 by the separation medium 2, the first moving element 4 can be located in the first chamber 46, as shown in FIG. 3, and can be in contact with or substantially adjacent to the separation medium 2.

Those skilled in the art may appreciate that the system can include three or more moving elements, for example as shown in FIGS. 10-23. Any of these moving elements can have any of the characteristics described herein with respect to the first moving element 4 and the second moving element 26.

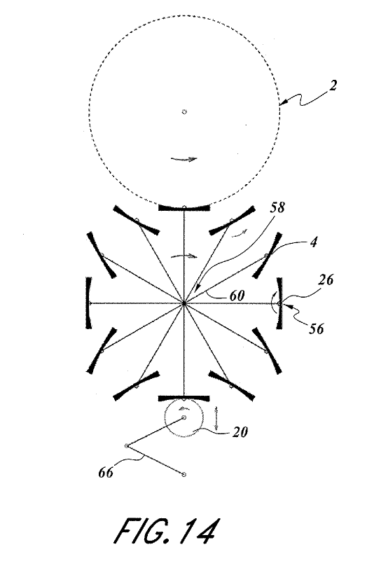

For example, as shown in FIG. 14, in one embodiment the system can include a plurality of moving elements (e.g., first moving element 4 and second moving element 26) that are adapted for motion in a direction substantially perpendicular to the separation medium 2 and that are part of a multi-axis rotation system. As shown in FIG. 14, each moving element (e.g., first moving element 4 and second moving element 26) can be adapted to rotate about axis adapted for rotation about axis 56. Each moving element can also be adapted to rotate about axis 58, for example, via connection to spoke 60. Those skilled in the art may appreciate that when the moving elements are made to move in two combined rotations, the rotations can be made to be equal in speed but opposite in direction (e.g., counterclockwise rotation about axis 56 and clockwise rotation about axis 58). Those skilled in the art may appreciate that in some embodiments the rotation of second moving element 26 about axis 56 relative to spoke 60 can be twice as fast as the absolute rotational speed about axis 58. Those skilled in the art may appreciate that when the moving elements are adapted to move in this way at a suitable position relative to a cylinder rotating with the same speed as the moving elements, the instantaneous relative motion between moving element and the point of contact or substantial adjacence with respect to the separation medium 2 can be generally parallel to the spoke 60 joining the two central axes. This relative motion can therefore be generally perpendicular to the separation medium 2 at the point of closest contact.

As shown in FIG. 14, the system can also include a hinged arm 68. The hinged arm 68 can be operatively attached to the removal element 20. Advantageously, the hinged arm 68 can be configured to allow the removal element 20 to move up and down and contact and/or remove liquid from the moving elements.

C. The Removal Element

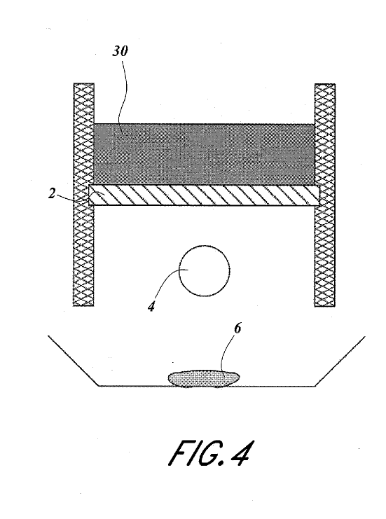

As shown in FIG. 3, when the moving element 4 is coated with liquid 6 to the point that it no longer pulls liquid 6 through, the moving element 4 can be removed away from the separation medium 2 and the liquid 6 can be removed from the moving element 4. Removal can take place using gravity and/or by an action such as scraping. Work, the input of energy, would often be required when removing the filtrate from the roller. Removal of liquid 6 from the surface of the first moving element 4 can result in a moving element 4 with little or no liquid 6 on its surface that would be available for use in a liquid separation process, as shown in FIG. 4. At that point, the moving element 4 can be brought back into proximity with the separation medium 2, and the process can be repeated.

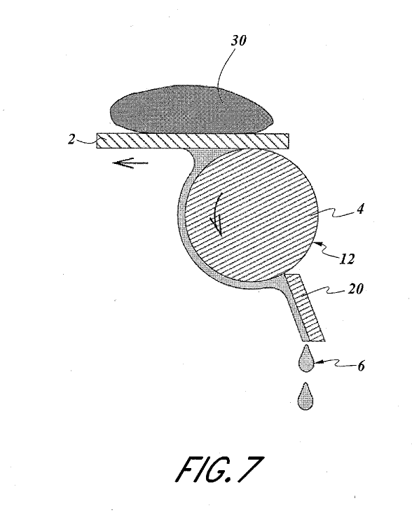

As shown in FIGS. 7-9, some embodiments can include a removal element 20. The removal element 20 can be in contact with or substantially adjacent to the first moving element 4. As shown in FIGS. 7-9, the removal element 20 can contact the first moving element 4. In other embodiments, the removal element 20 can be substantially adjacent or near to the first moving element 4. The removal element 20 can be adapted to remove at least some liquid 6 from the first moving element 4.

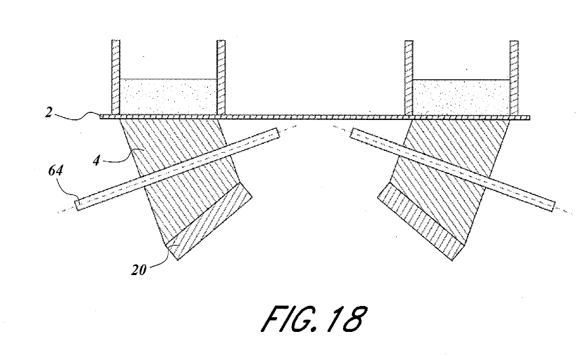

The removal element 20 can have a variety of configurations, such as those described herein with respect to the first moving element 4 and/or the second moving element 26. As shown in FIGS. 7 and 18, the removal element 20 can be a non-rotational scraper. The scraper can be adapted to scrape the outer surface 12 of the first moving element 4, as shown in FIGS. 7 and 18.

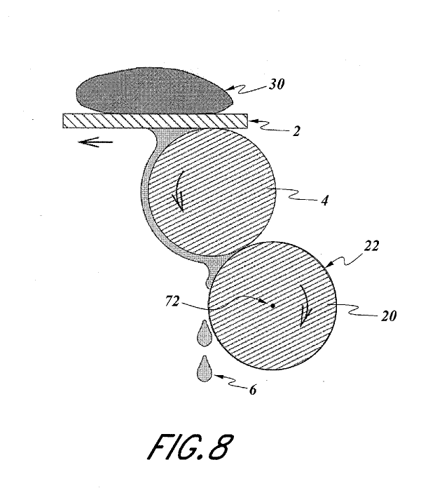

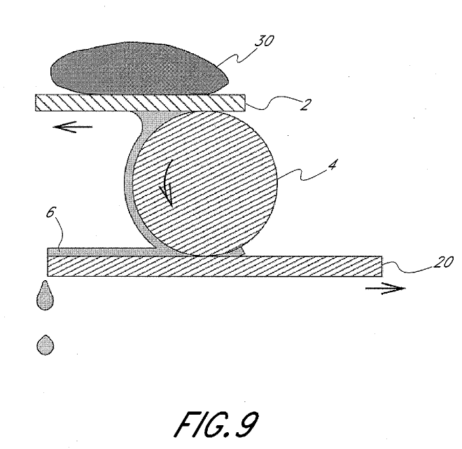

As shown in FIG. 8, the removal element 20 can be a cylindrical roller adapted to be in relative rotational motion with the first moving element 4. The cylindrical roller can rotate about axis 72. Liquid 6 can be removed from the first moving element 4 by rolling the first moving element 4 near or against the roller removal element 20. The diameter of the cylindrical roller can vary over a wide range and can be selected according to principles known to those skilled in the art, and can be based on one or more properties of the mixture and/or the system components. For example, in some embodiments a cylindrical removal element 20 can have a diameter in the range of from about 0.1 in to about 10 in. In other embodiments, the cylindrical removal element 20 can have a diameter in the range of from about 0.5 in to about 3 in. In yet other embodiments, the cylindrical removal element 20 can have a diameter in the range of from about 0.2 in to about 5 in. In some embodiments, the diameter of a cylindrical removal element 20 can be generally the same as the diameter of a cylindrical first moving element 4. In other embodiments, the diameter of a cylindrical removal element 20 can be different (e.g., larger or smaller) than the diameter of a cylindrical first moving element 4. In FIG. 8, the removal element 20 can also be adapted to be in relative translational movement with the first moving element 4. As shown in FIG. 9, the removal element 20 can be relative translational sliding motion with the first moving element 4. In FIG. 9, the removal element 20 and the first moving element 4 can contact each other and can be in relative rotational and/or translational sliding movement. As further shown in FIG. 9, the removal element 20 can be generally parallel to the separation medium 2.

As shown in FIG. 16, the removal element 20 can be a frustoconical roller (e.g., truncated cone shape). As further shown in FIG. 16, in some embodiments both the first moving element 4 and the removal element 20 can be frustoconical rollers. The diameter of the frustoconical removal element 20 can also vary over a wide range. In some embodiments, the major diameter of a frustoconical removal element 20 can be similar to the diameter of the cylindrical removal element 20 as described herein. In some embodiments, the removal element 20 can be solid or hollow (e.g., a hollow roller or hollow truncated cone).

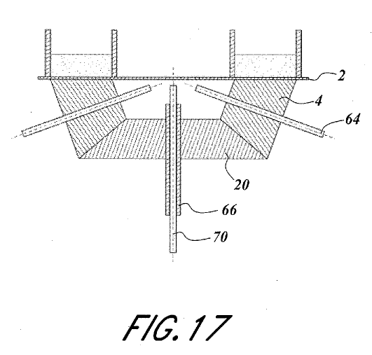

As shown in FIGS. 16-17, in some embodiments the rotation of the removal element 20 can be driven by shaft 66. Shaft 66 can be connected to, for example, a motor. This can be advantageous in embodiments that include one removal element 20 for multiple moving elements. In some embodiments, the rotation of shaft 66 can drive the rotation of the removal element 20 and the first moving element 4. In other embodiments, the rotation of shaft 64 can drive the rotation of first moving element 4 and removal element 20. As shown in FIG. 17, shaft 66 can be hollow and can include inner shaft 70 disposed within the hollow lumen. In these embodiments, inner shaft 70 can be fixed (e.g., not adapted for rotational movement) and can be used as a support structure.

The removal element 20, when adapted for rotational motion, can be adapted to rotate at a variety of speeds. In some embodiments, the removal element 20 can rotate at a speed faster than about 240 RPM. In other embodiments, the removal element 20 can rotate at a speed in the range of from about 300 RPM to about 2000 RPM. In yet other embodiments, the removal element 20 can rotate at a speed in the range of from about 500 RPM to about 2000 RPM. Those skilled in the art may appreciate that a particular rotational speed may be selected depending on a number of factors, such as the diameter of the removal element 20 (e.g., a cylindrical or frustoconical removal element 20). In some embodiments, the removal element 20 can have a diameter in the range of from about 0.5 in to about 3 in and can be adapted to rotate about axis 72 at a speed in the range of from about 500 RPM to about 2000 RPM.

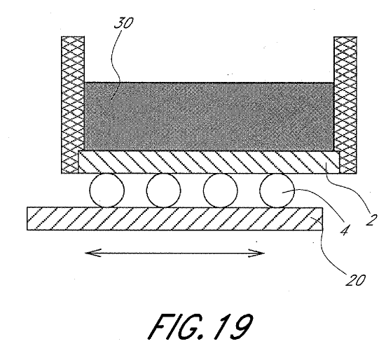

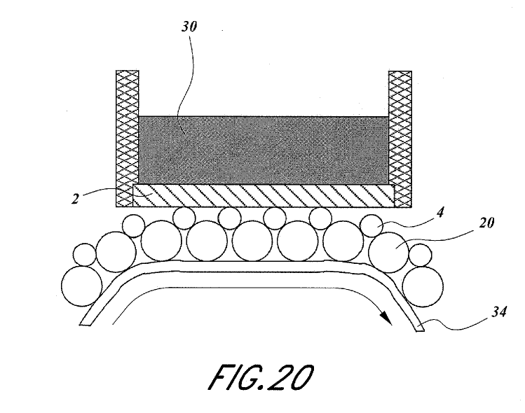

In some embodiments, the relative motion between first moving element 4 and separation medium 2 can be reciprocal. For example, as shown in FIG. 19, the first moving element 4 and/or generally planar removal element 20 can translate in one direction for a certain distance and then reverse direction to translate back to the original starting point. In other embodiments, the relative motion between first moving element 4 and separation medium 2 can be continuous. For example, as shown in FIG. 20, the first moving element 4 and the cylindrical removal element 20 can translate continuously in one direction indicated by the arrow. This can be accomplished through the use of a conveyor belt 34 or a looped filter cloth. As illustrated in FIG. 20, multiple moving elements and/or multiple removal elements can translate relative to the separation medium 2. In these embodiments, the moving elements can be recycled through the system. Advantageously, these embodiments can also be used for cyclical separation, for example where a plurality of moving elements each having different qualities is recycled through the system.

The removal element 20 can be made from a variety of materials, such as one or more of a metal, polymer (e.g., a silicone or latex polymer), glass, rubber, wood, or ceramic. In one embodiment, at least a portion of the removal element 20 (e.g., outer surface 22, as shown in FIG. 8) can include a silicone or latex polymer. In another embodiment, at least a portion of removal element 20 (e.g., outer surface 22) can include rubber. Those skilled in the art may appreciate that the removal element 20 can include a plurality of materials and/or layers. For example, the removal element 20 can include a metal core with a polymeric outer surface 22.

In some embodiments, the removal element 20 can include a material that affects the forces of intermolecular attraction between removal element 20 and the liquid 6. The removal element 20 can be hydrophilic, oleophilic/lipophilic, hydrophobic, and/or amphiphilic. In some embodiments, the removal element 20 is hydrophilic and has an HLB (hydrophilic-lipophilic balance) value in the range of from about 16 to about 20. In some embodiments, the removal element 20 can have a contact angle with water of about 90° or less. In other embodiments, the removal element 20 can have a contact angle with water of about 70° or less. In yet other embodiments, the removal element 20 can have a contact angle with water in the range of from about 30° to about 70°. In other embodiments, the removal element 20 is lipophilic and has an HLB value in the range of from about 0 to about 3. In some embodiments where the removal element 20 is hydrophobic, the removal element 20 can have a contact angle with water that is greater than 90°. In some embodiments, the removal element 20 can include a surfactant and/or wetting agent. In yet other embodiments, the removal element 20 can include a material that is adapted to carry/maintain an electrostatic charge. For example, the removal element 20 can include one or more ionic materials, such as an anionic, cationic, or zwitterionic material.

In other embodiments the removal element 20 can include a coating that includes one or more substances such as a polymer, oil, or wax. The coating can be hydrophilic, oleophilic/lipophilic, hydrophobic, and/or amphiphilic. In some embodiments, the coating is hydrophilic and has an HLB (hydrophilic-lipophilic balance) value in the range of from about 16 to about 20. In other embodiments, the coating is lipophilic and has an HLB value in the range of from about 0 to about 3. In some embodiments, the coating can include a surfactant and/or wetting agent. Those skilled in the art may appreciate that the coating can be selected based upon the properties of the liquid to be separated. For example, a hydrophilic coating may be selected when the liquid to be separated is also hydrophilic, such as water. In yet other embodiments, the removal element 20 can include a coating that is adapted to carry/maintain an electrostatic charge. For example, the coating can include one or more ionic materials, such as an anionic, cationic, or zwitterionic material.

The outer, surface 22 of the removal element 20 can be rigid or flexible/compliant. In some embodiments, the removal element 20 can have a substantially rigid outer surface 22. In other embodiments, the outer surface 22 can be substantially non-porous and/or substantially non-absorbent. As described further herein, the outer surface 22 can be non-smooth, which can advantageously assist in pulling the liquid 6 off of and away from the first moving element 4.

The rigidity or flexibility/compliance of the outer surface 12 of the first moving element 4 can differ from that of the outer surface 22 of the removal element 20. For example, the outer surface 12 of the first moving element 4 can be substantially rigid and the outer surface 22 of the removal element 20 can be substantially flexible and/or compliant. This combination can advantageously increase the efficacy of liquid removal and can reduce the need for precise alignment between the first moving element 4 and removal element 20.

The system can include a plurality of removal elements 20. As shown in FIG. 12, the system can include one removal element 20 for each moving element. In other embodiments, the system can include one removal element 20 for several (e.g., 2, 3, 4, or 5) moving elements. As shown in FIG. 10, for example, not all moving elements may be associated with a removal element 20. For example, a system can include a second moving element 26 that does not contact any removal element and that is adapted to maintain the presence of liquid 6 on the first surface 8 of the separation medium 2. Thus, a system can include more moving elements than removal elements 20. In another example, a system can include one or more moving elements associated with a removal element 20 and one or more moving elements not associated with a removal element 20. In yet another example, such as in FIG. 17, the system can include a single removal element 20, regardless of the number of moving elements. In still another example, the system may not include any removal element 20.

In some embodiments, the first moving element 4 can be a cylindrical roller (e.g., a moving roller), the separation medium 2 can be a filter, and the removal element 20 can be a cylindrical roller (e.g., a removal roller). In these embodiments, the cylindrical roller can be rolled over the first surface 8 of the filter. The cylindrical roller may acquire a layer of liquid 6 all around it. The removal roller can contact the moving roller. If the two cylindrical rollers covered with liquid rotate against each other, the liquid collects where they meet and can be removed by the removal roller. Generally, one can provide extra energy to do this: rotating a wet roller against another can require more torque than rotating two dry rollers against each other. Physically, the liquid may be attracted to the surface of the roller and may therefore require energy for removal. Those skilled in the art may appreciate that these advantages may also be realized through the use of frustoconical rollers for both the first moving element 4 and the removal element 20, for example as shown in FIG. 16.

In certain embodiments, a system can comprise one roller rolling against a filter and rolling another roller (e.g., a removal roller) against the first roller. This energy can then be used, by means of “surface tension” (e.g., the attraction of the liquid to the roller surface), to pull more liquid through the filter.

D. Storage Element

As shown in FIGS. 12-13, some embodiments can include a storage element 24. The storage element 24 can be adapted to receive liquid 6 after it has passed through the separation medium 2. The storage element 24 can be located more proximate to the first surface 8 of the separation medium 2 than the second surface 10 of the separation medium 2. The storage element 24 can also be in fluid communication with the first moving element 4 and/or the removal element 20. For example, as shown in FIGS. 12-13, liquid 6 can flow from removal element 20 to storage element 24. In some embodiments, liquid 6 can flow from the first moving element 4 to the storage element 24. In some embodiments, the storage element 24 can be a collection tray, a basin, a holding tank, or a container. In some embodiments, the storage element 24 can include a funnel that directs filtered liquid into the tray.

As further shown in FIGS. 12-13, the storage element 24 can be below one or more of the first moving element 4 and the removal element 20. As shown in FIG. 12, one or more of the first moving element 4, removal element 20, and storage element 24 may be inside a cylindrical separation medium 2. As shown in FIG. 13, one or more of the first moving element 4, removal element 20, and storage element 24 may be outside a cylindrical separation medium 2.

Power can be required to drive the motion of the first moving element 4, removal element 20, storage element 24, and/or separation medium 2. In some cases the separation medium 2 can be pulled, or in a few cases pushed, through and is strong enough to drive the motion of the other elements. Moving elements can be driven, for example, by a motor. Removal elements can be similarly driven, which can be especially convenient when one removal element drives the movement of more than one moving element. It is also possible to introduce an additional element that drives the other elements.

Support of the various elements, of their absolute and relative positions, may be required. The moving elements can be kept at appropriate locations relative to the separation medium. The process of removal may depend significantly on the relative positions of pulling and removal elements. For example, rolling one roller against another may require that they be held quite tightly together.

Overall structural support of the various components of the system can be included to hold the system together. The embodiments herein may be advantageous in this regard. As shown in FIG. 11, the system can include one or more guide rollers 74 adjacent either surface of the separation medium 2. The guide rollers 74 can guide and/or maintain alignment of the separation medium 2 which can be particularly advantageous when the separation medium 2 and/or moving elements are in relative movement. In another example, a removal element can be advantageously used to support moving elements which can in turn support the separation medium and mixture.

E. Regeneration/Priming and Agitation/Backwash

As described herein, the system can include a plurality of moving elements, removal elements, and/or separation media. In some embodiments, one or more moving elements, such as second moving element 26, can be adapted to maintain at least some of liquid 6 on the first surface 8 of the separation medium 2 and/or can be adapted to move at least some of liquid 6 back through the separation medium 2 from the first surface 8 to the second surface 10.

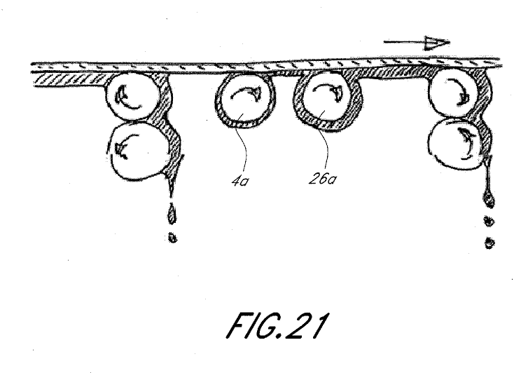

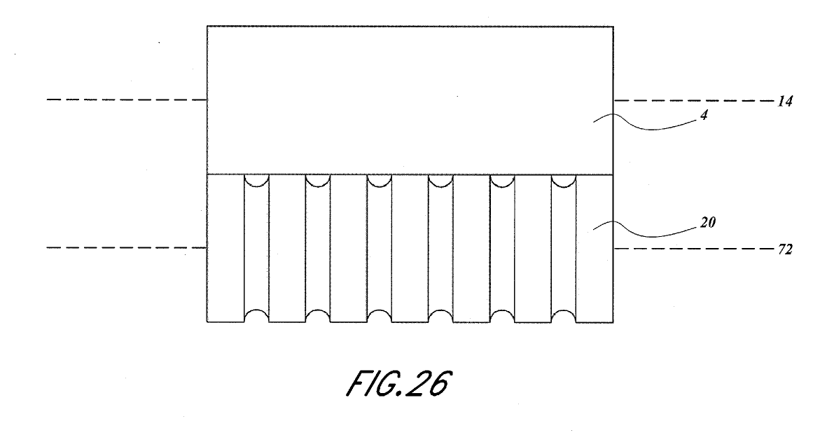

The combination of moving elements and removal elements may be so effective that moving and/or removing elements that encounter the separation medium later in sequence may have limited efficacy. Although not bound by theory, one reason may be that there is little liquid 6 on the first surface 8 of the separation medium 2. This can make subsequent moving elements inefficient in pulling liquid 6 through the separation medium 2 and can also limit the quantity of liquid 6 available to coat the first moving element 4. One means of improving the efficiency of liquid removal is to use moving elements without corresponding removal elements, or with deliberately inefficient removal elements that result in partial liquid removal, as shown in FIG. 26. As described herein, in some embodiments the system is adapted to maintain at least some liquid on each moving element and/or on the first surface 8 of the separation medium 2. As shown in FIG. 21, as the separation medium 2 passes first and second moving elements 4a, 26a that are not associated with any removal element, the liquid coating on the separation medium 2 increases. Those skilled in the art may appreciate that in some embodiments, a system can include a moving element that is not associated with a corresponding removal element and that can be adapted to pull liquid through the separation medium from the second surface to the first surface, and a subsequent moving element in series that is associated with a corresponding removal element and that can be adapted to remove liquid from the first surface of the separation medium.

A moving element that is adapted to move at least some of liquid 6 back through the separation medium 2 from the first surface 8 to the second surface 10 can be advantageous for generating backwash and agitation, which can be a beneficial unclogging mechanism. One problem that can be encountered in some liquid separation systems and methods is that the residue can clog the separation medium 2. Those skilled in the art may appreciate that using a moving element to push liquid 6 back through the separation medium 2 from the first surface 8 to the second surface 10 can help to unclog the separation medium 2. This scheme can be employed in a succession of stages. Moving elements 4b that are not associated with any removal elements can also have the benefit of applying a small amount of backwash and agitation. Incorporating an unclogging component into the system can be advantageous. For example, the systems as described herein can be suitable for continuous processes. Since the system need not be stopped to clean and/or change the filter, the system can operate relatively efficiently. In addition, because the separation medium 2 may be subject to relatively little clogging as a whole, the overall system can run more efficiently.

F. Combination with Other Processes

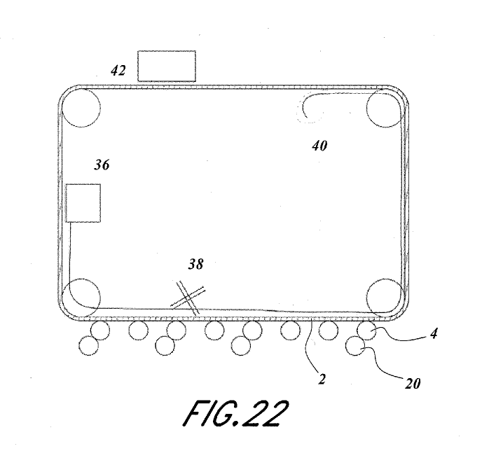

As shown in FIG. 22, some systems herein can combine one or more moving elements and/or removal elements with additional stations adapted for one or more steps in the liquid separation process. FIG. 22 illustrates a particular system having one or more moving elements 4 and removal elements 20 interacting with other components, including an inserter 36, an agitator, an extractor 40, and backwash station 42. The system can include an inserter 36 wherein a mixture that includes a liquid can be introduced. The system can also include an agitator 38 that agitates the mixture to avoid the settling of solids/residue on the second surface 10 of the separation medium 2. The system can also include an extractor 40 that allows for removal of residue. The system can further include a backwash station 42 which can be adapted to more thoroughly remove residue and clean the separation medium 2 in preparation for re-entering the cycle. Advantageously, the systems described herein, such as the system shown in FIG. 22, can be used in continuous liquid separation processes in, for example, a water treatment or sewage facility, although the application is not limited to these contexts. For example, the cycle of introducing a mixture, removing liquid, removing filtrate, and cleaning the separation medium can occur continuously. The system need not shut down in order to accomplish one or more of these steps. Those skilled in the art may appreciate that FIG. 22 illustrates merely one example of a system described herein, and that other systems may include only some of the stations shown in FIG. 22 or may include other stations not shown in FIG. 22. For example, any of the systems described herein may include one or more of these auxiliary stations, along with the appropriate inlet(s) and/or outlet(s). Those skilled in the art may understand how to select such auxiliary stations.

G. Enhancements

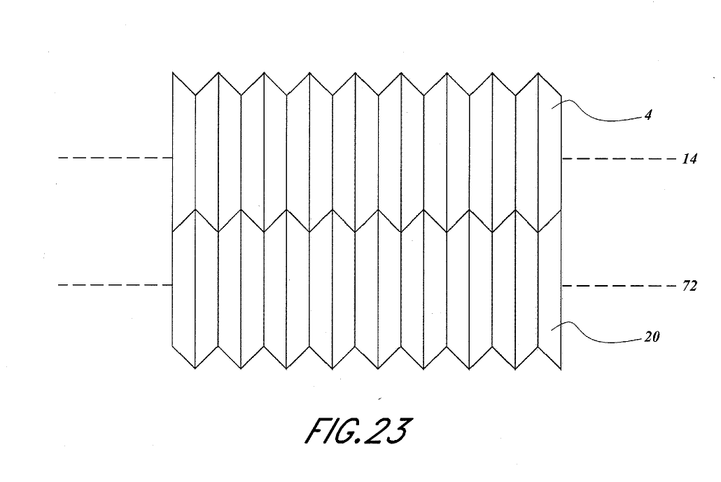

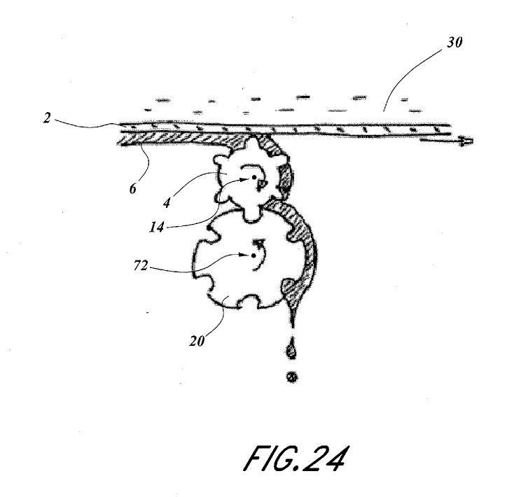

As described herein, one or more moving elements (e.g., first moving element 4 or second moving element 26) and/or removal elements (e.g., removal element 20) can include a non-smooth outer surface. For example, the outer surface 12 of the first moving element can include fine-scale features that are roughened. The outer surface 12 can also or alternatively include coarse-scale features. This includes texturing, ridges, grooves, protrusions, bumps, knurling, threads, and random surface features. The patterns of outer surfaces may be chosen for compatibility with a certain geometrical characteristic of separation medium. For example, a fine mesh with small pores can be matched with a moving element having an outer surface configuration at a similar scale. In some embodiments, the outer surface configuration can be selected based upon at least the orientation of the moving element with respect to the separation medium 2. For example, the outer surfaces of moving elements that move substantially perpendicularly to the separation medium 2, such as those shown in FIG. 14, can include ridges or protrusions at or near the edges. The non-smooth outer surface can advantageously engage and break up the continuous surface of the liquid 6 on the first surface 8 of the separation medium 2, which can the efficiency of liquid removal from the first surface 8 as compared to removal using moving and/or removal elements having a smooth surface. The surface of the moving and/or removal elements can be designed and made so that pulling and removal of liquid is efficient. The shapes of moving and/or removal elements may be designed to maximize pulling of liquid through the separation medium and to maximize removal of liquid from the moving elements. Shapes that interact or interleave, such as the interleaved grooves of FIG. 23 and the involute gears of FIG. 24, can perform advantageously to maximize pulling of liquid through the separation medium as compared to other non-smooth outer surface textures.

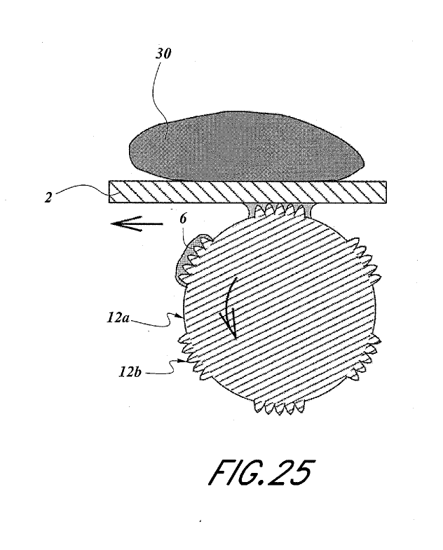

The surface configurations of moving and/or removal elements may have no repeated pattern, may be aligned perpendicularly (FIG. 23) or in parallel (FIG. 24) to first axis of rotation 14, or may have a non-aligned repeated pattern such as a helix. A mixed pattern with features at multiple scales may be used. For example, as shown in FIG. 25, the outer surface 12 of first moving element 4 can include some portions 12a that are generally smooth and some portions 12b that have a roughened texture. As shown in FIG. 25, variations in the surface configuration of first moving element 4 can affect its attractive interactions with liquid 6. Those skilled in the art may appreciate that surface configurations can be varied depending on a number of factors, such as the properties of the particular mixture and liquid to be separated.

As described herein, the system can include a plurality of moving elements and/or removal elements. In some embodiments, the plurality of moving elements and/or removal elements can have a variety of different surface configurations. As shown in FIG. 26, first moving element 4 can have a generally smooth outer surface 12 and removal element 20 can have a grooved outer surface 22.

In some embodiments, the removal of liquid from a moving element can be designed to be deliberately inefficient, so that some liquid is left on the moving element. This can improve liquid throughput by helping to maintain liquid contact between the separation medium and moving elements, thereby providing a continuous flow through the separation medium. The surface configurations of the moving and/or removal elements can be chosen so that at least some liquid is left on the moving elements, such as by incorporating grooves in the removal element 20, as shown in FIG. 26.

H. Systems Adapted for Continuous or Batch Processes

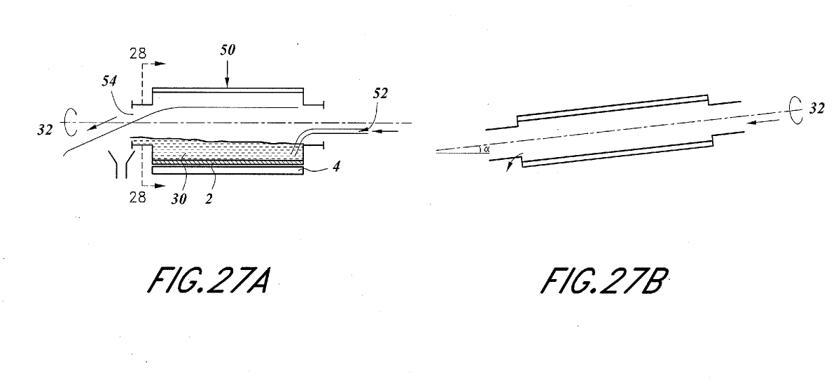

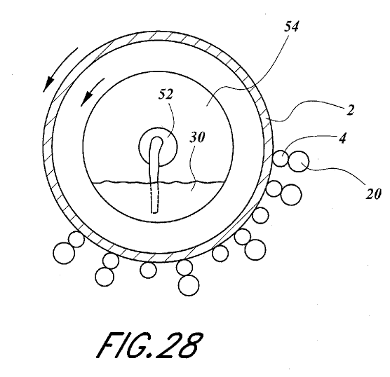

As described herein, the systems herein can advantageously be adapted for continuous liquid separation processes that require minimal (if any) stopping between different steps. Continuous processes may be advantageous because they can be run continuously without having to rely on supervision. In some embodiments, a continuous process can be more efficient and easier to control relative to non-continuous processes (e.g., non-continuous batch processes). Examples of a system adapted for continuous liquid separation are shown in FIGS. 27A-B and FIG. 28. A system employing a cylindrical separation medium 2 adapted to rotate about an axis that is generally horizontal, as shown in FIG. 27A, can be designed to hold a mixture 30 in sufficient quantity that it flows to the bottom part of the inside of the cylinder via inlet 52. In use, the bottom of the cylinder can be filled with the mixture 30. As the cylindrical separation medium 2 rotates about the axis 32, the residue can reach the top of the cylinder where vent 50 can blow air to remove the residue from the cylinder for removal via outlet 54. In some embodiments, the top of the cylinder can also include a scraper (not shown) to assist in removing the residue. Residue removal, backwashing, and other processes can be placed above the cylinder (e.g., near the top of the cylinder and adjacent the outer surface).

A system employing a cylindrical separation medium can have its axis of rotation arranged at an angle α to the horizontal plane, as shown for example in FIG. 27B. An angled cylinder in a continuous process can advantageously dry the residue more completely, with different processes at different parts of the cylinder. The angle α of the axis of rotation of the cylindrical separation medium can vary, and can be, for example, in the range of from about 10° to about 90° relative to the horizontal plane. In another example, the angle α of the axis of rotation of the cylindrical separation medium can be in the range of from about 1° to about 30° relative to the horizontal plane. In these examples, a small quantity of mixture can be introduced at the higher end such that it coats the cylindrical separation medium and moves along the axis of the cylindrical separation medium by a combination of gradual flow and rotation of the cylindrical separation medium about its axis of rotation. In addition, the mixture can move along the cylinder by being scraped off or blown off by vent 50 at the top and falling to a relative location further downstream (e.g., closer to the outlet 54 and/or the lower end).

In some embodiments, the systems described herein are adapted for batch processes. In a batch process, the liquid separation process may not be continuous and may need to be stopped periodically. For example, a system shown in FIG. 16 can be adapted for a batch process. In this embodiment, the separation medium can be a cartridge that can be inserted, into the system, used for liquid separation, and then removed for further processing (e.g., cleaning).

In some embodiments, the systems described herein may combine a plurality of liquid separation devices for a multistage system that includes multiple liquid separation stages. Some separation designs tend toward an all-at-once approach. Advantageously, if multiple stages are used, each stage can be simplified. Also, separation can be performed without driving the residue as hard into the separation medium, which can increase the life of the separation medium and can reduce clogging of the separation medium. In some embodiments, the systems described herein can be adapted for one stage in a multistage separation process that is combined with one or more separation stages. For example, a filtration step of such form may be used to preprocess a mixture before vacuum filtering.

As described herein, the system can include a computer system for controlling one or more of the components. In some embodiments, the computer system can control the first moving element 4. In other embodiments, the computer system can control the separation medium 2. In yet other embodiments, the computer system can control the removal element 20. Some embodiments herein are directed to fully automated, computerized systems.

### II. Methods

Some embodiments herein are directed to methods for liquid separation. Any of the systems or components thereof described herein can be used with these methods. Some embodiments can include moving at least a portion of an outer surface 12 of a first moving element 4 into contact with or substantially adjacent to a first surface 8 of a separation medium 2. The separation medium 2 can further include a second surface 10 opposite the first surface 8, and the second surface 10 can be in contact with a mixture 30 that can include a liquid 6. The movement can urge a first amount of liquid 6 to move across the separation medium 2 from the second surface 10 to the first surface 8 to contact the outer surface 12 of the first moving element 4. Some embodiments can further include moving the portion of the outer surface 12 of the first moving element 4 away from the first surface 8 to cause the first amount of liquid 6 to be removed from the separation medium 2.

Some embodiments can include applying at least a portion of an outer surface 12 of a first moving element 4 to a first surface 8 of a separation medium 2 to contact or be substantially adjacent to the separation medium 2, wherein the separation medium 2 further includes a second surface 10 opposite the first surface 8 that is in contact with a mixture 30 comprising a liquid 6; and generating fluid forces between the outer surface 12 of the first moving element 4 and the first surface 8 of the separation medium 2 to pull the liquid 6 through the separation medium 2 from the second surface 10 to the first surface 8.

Other embodiments can include providing a system for liquid separation comprising an at least partially enclosed space, a separation medium 2, and a first moving element 4, wherein the at least partially enclosed space is divided into a first chamber 46 and a second chamber 48 by the separation medium 2 and the first moving element 4 is located in the first chamber 48 and is in contact with or substantially adjacent to the separation medium 2; introducing a mixture 30 comprising liquid into the second chamber 48; and moving the first moving element 4 to generate one or more of surface tension, hydrodynamic, and hydrostatic forces to pull the liquid 6 through the separation medium 2 from the second chamber 48 into the first chamber 46. In some embodiments, the step of moving the first moving element 4 can include placing the first moving element 4 in rotational and/or translational movement relative to the separation medium 2. In some embodiments, the method can further include contacting the outer surface 12 of the first moving element 4 with the liquid 6 pulled into the first chamber 46.

Any mixture that includes a liquid to be separated can be used with the systems and methods described herein. For example, the mixture 30 in contact with the second surface 10 of the separation medium 2 can include the liquid 6 intermixed with a solid or a second liquid. Examples of solids include macroscopic materials such as dirt and particulate matter, and microscopic materials such as biological organisms (e.g., bacteria). In some embodiments, the mixture 30 can include a solution that includes liquid 6, such as a salt water solution.

Advantageously, in some embodiments the mixture 30 may not be compressed adjacent to the second surface 10 of the separation medium 2. For example, the mixture 30 may be exposed only to atmospheric pressure.

In some embodiments, the step of moving at least a portion of the outer surface 12 of the first moving element 4 towards and away from the first surface 8 of the separation medium 2 can generate one or more of surface tension, hydrodynamic, and hydrostatic forces to pull the first amount of liquid 6 away from the separation medium 2. For example, the step of moving at least a portion of the outer surface 12 of the first moving element 4 towards and away from the first surface 8 of the separation medium 2 can generate surface tension to pull the first amount of liquid 6 away from the separation medium 2. In another example, the step of moving at least a portion of the outer surface 12 of the first moving element 4 towards and away from the first surface 8 of the separation medium 2 can generate a hydrodynamic force to pull the first amount of liquid 6 away from the separation medium 2. In yet another example, the step of moving at least a portion of the outer surface 12 of the first moving element 4 towards and away from the first surface 8 of the separation medium 2 can generate a hydrostatic force to pull the first amount of liquid 6 away from the separation medium 2.

In other embodiments, the step of moving at least a portion of the outer surface 12 of the first moving element 4 towards and away from the first surface 8 of the separation medium 2 can reduce the fluid pressure exerted at the first surface 8 of the separation medium 2 relative to the second surface 10 of the separation medium 2. In even other embodiments, the step of moving at least a portion of the outer surface 12 of the first moving element 4 towards and away from the first surface 8 of the separation medium 2 can reduce the surface tension of the liquid 6 at the first surface 8 of the separation medium 2 relative to the second surface 10 of the separation medium 2. In yet other embodiments, the step of moving at least a portion of the outer surface 12 of the first moving element 4 towards and away from the first surface 8 of the separation medium 2 can increase the flow of the liquid 6 through the separation medium 2 as compared to the flow of the liquid through the separation medium 2 in the absence of the first moving element 4.

The method can further include removing at least some of the first amount of the liquid 6 from the outer surface 12 of the first moving element 4 by contacting the outer surface 12 of the first moving element 4 with a removal element 20. Any of the removal elements 20 described herein can be used. For example, one embodiment can include removing at least some of the liquid in contact with the outer surface 12 of the first moving element 4 via a scraping element (e.g., a non-rotational scraper). Another embodiment can include removing at least some of the liquid in contact with the outer surface 12 of the first moving element 4 via a rolling element (e.g., a cylindrical or frustoconical roller).

Some embodiments herein are directed to continuous methods which allow for multiple steps to be performed without pause. The steps can be repeated one or more times. Some embodiments can further include moving a portion of the outer surface 12 of the first moving element 4 into contact with or substantially adjacent to the first surface 8 of the separation medium 2. The second surface 10 of the separation medium 2 can be in contact with the mixture. Movement of the portion of the outer surface 12 can urge a second amount of liquid to move through the separation medium 2 from the second surface to the first surface to contact the outer surface 12 of the first moving element 4. The method can further include moving the portion of the outer surface 12 of the first moving element 4 away from the first surface 8 to remove the second amount of liquid 6 from the separation medium 2. Those skilled in the art may recognize that as long as the first moving element 4 is moving towards and away from the separation medium 2, some amount of liquid may be urged through the separation medium 2 from the second surface 10 to the first surface 8.

As described herein, systems for liquid separation can include a plurality of moving elements (e.g., two or more). Accordingly, in some embodiments the methods can further include translating at least a portion of the separation medium 2 away from the first moving element 4 and towards a second moving element 26, for example as illustrated in FIGS. 2 and 10; moving at least portion of an outer surface 44 of the second moving element 26 into contact with or substantially adjacent to the first surface 8 of the separation medium 2, wherein the movement urges a second amount of liquid to move across the separation medium 2 from the second surface 10 to the first surface 8 to contact the outer surface 44 of the second moving element 26; and moving the at least a portion of the outer surface 44 of the second moving element 26 away from the first surface to cause the second amount of liquid 6 to be removed from the separation medium 2. In some embodiments, the first moving element 4 and/or separation medium 2 of the systems described herein can be adapted for translational motion relative to each other. Therefore, those skilled in the art may appreciate that in some embodiments, the second moving element 26 may be translated towards the at least a portion of the separation medium 2, instead of or in addition to translating the at least a portion of the separation medium 2 towards the second moving element 26.

Some embodiments can further include causing a second amount of liquid 6 to be moved through the separation medium 2 from the second surface 10 to the first surface 8 by moving at least a second portion of the outer surface 12 of the first moving element 4 into contact with or substantially adjacent to the first surface 8; causing the second amount of liquid to be removed from the separation medium by moving the second portion of the first moving element away from and out of fluid communication with the first surface; and moving the second portion of the outer surface of the first moving element 4 away from the first surface 8 to remove the second amount of liquid from the separation medium 2. These embodiments may apply, for example, when the systems shown in FIGS. 27A-B and 28 are used to carry out the methods of liquid separation.

As described herein, some systems can include a plurality of moving elements. Some moving elements can be associated with a removal element 20 and can be adapted to remove liquid 6 from a mixture 30. Other moving elements may not be associated with a removal element 20, and may be adapted for other purposes, such as to unclog the separation medium 2. Accordingly, some methods can include unclogging the separation medium 2. These methods can include moving a second amount of liquid through the separation medium 2 from the second surface 10 to the first surface 8 by moving at least a portion of an outer surface 44 of a second moving element 26 into contact with or substantially adjacent to the first surface 8; removing the second amount of liquid 6 from the separation medium 2 by moving the portion of the second moving element 26 away from the first surface 8; and moving at least a portion of the second amount of liquid 6 back through the separation medium 2 from the first surface 8 to the second surface 10 by moving the portion of the second moving element 26 to be placed into contact with or adjacent to the first surface 8 to unclog the separation medium 2. Advantageously, this method may not require any other instrumentation to unclog the separation medium.

In other embodiments, the step of unclogging the separation medium can include applying an outer surface of a second moving element to the first surface of the separation medium; generating fluid forces between the surface of the second moving element and the first surface of the separation medium in a first direction to thereby pull the liquid through the separation medium from the second surface to the first surface; and generating fluid forces between the surface of the second moving element and the first surface of the separation medium in a second direction generally opposite the first direction to thereby push the liquid through the separation medium from the first surface to the second surface.

In yet other embodiments, a moving element may be adapted to maintain some amount of liquid 6 on the first surface 8 of the separation medium 2, such as first and second moving elements 4a and 26a in FIG. 21. As described herein, the first surface 8 and/or the outer surfaces of the moving elements may need to retain at least some liquid 6 in order to generate fluid forces with respect to the first surface 8 of the separation medium 2 and effectively urge the liquid 6 through the separation medium 2. Thus, some methods may include intentionally adding liquid to (e.g., establishing, reestablishing and/or maintaining a liquid coating on) the separation medium 2. These methods can include moving a second amount of liquid 6 through the separation medium 2 from the second surface 10 to the first surface 8 by placing at least a portion of an outer surface 44 of a second moving element 26 in contact with or substantially adjacent to the first surface 8; removing the second amount of liquid 6 from the separation medium 2 by moving the portion of the second moving element 26 away from the first surface; and applying at least a portion of the second amount of liquid 6 to the first surface 8 by placing the portion of the second moving element 26 into contact with or substantially adjacent to the first surface 8.

Advantageously, first and second moving elements 4a and 26a can also work together with other moving elements that are associated with removal elements. In some embodiments, first and/or second moving elements 4a and 26a can pull an amount of liquid through the separation medium 2 to the first surface 8, and one or more other moving elements associated with a removal element can remove the amount of liquid 6 from the first surface 8. The amount of liquid 6 can then be removed from the moving element using removal element 20.

In other embodiments, the step of intentionally adding liquid to the separation medium can include applying a second moving element to the first surface of the separation medium; generating fluid forces between the surface of the second moving element and the first surface of the separation medium in a first direction to thereby pull the liquid through the separation medium from the second surface to the first surface; and generating fluid forces between the surface of the second moving element and the first surface of the separation medium in a second direction generally opposite the first direction to thereby apply at least some of the liquid onto the first surface of the separation medium.

Those skilled in the art may appreciate that the methods described herein may include one or more of the steps described herein. In some embodiments, one or more steps may be repeated. In other embodiments, one or more steps may be excluded. In yet other embodiments, one or more additional steps may be added. For example, some embodiments can include urging liquid through the separation medium, removing liquid from the first moving element, unclogging the separation medium, and intentionally adding liquid to the separation medium. Other embodiments can include urging liquid through the separation medium, removing liquid from the first moving element, intentionally adding liquid to the separation medium, and unclogging the separation medium.

One of the advantages of the systems and methods described herein is that they can be used for continuous liquid separation processes. Accordingly, mixture can be introduced and liquid can be removed continuously without stopping the system. The steps described herein can be repeated one or more times as desired, for example until a desired amount of mixture has been input or until a desired amount of liquid has been removed.

### III. Applications

The systems and methods described herein can be used in many solid-liquid and liquid-liquid separation applications. Sometimes the primary product is the liquid, while other times is it the residue. Sometimes the need is to remove most of the liquid component from the mixture, such as drying a solid. Sometimes results are useful if a small amount of the liquid component is removed from the mixture.

Examples of liquid separation applications can include purification and residue removal in chemical production, where the desired product is the purified liquid; solvent removal in pharmaceuticals, where the product is the solid; paper making; sewage treatment, where removal of solids reduces subsequent treatment cost. Examples of applications for liquid-liquid separation include desalination, energy, and/or fuel cell. Liquid-liquid separation may be of increased importance with the development of specialized membranes, sometimes using nanotechnology.

In some embodiments, between about 10% and 90%, or between about 30% and 60% of the water can be removed. Examples of applications where almost all liquid may be removed from a mixture, and sometimes combined with washing, include the manufacture of a drug or chemical products, and processes such as solvent extraction and precipitation which can lead to a stage in which a liquid needs to be extracted from a mixture. Either or both the residue and filtrate can be useful products or reused in further processing.

One example of an application that may utilize incomplete extraction of a liquid from a mixture is desalination. In desalination, the product can be partially or completely purified water. There is no shortage of sea water, and so there may be no need to remove a significant proportion of water. Hence the residue may have only a very slightly increased concentration of salt.

One application where incomplete separation can be advantageous, such as with a solid-liquid mixture that is difficult to separate, but where separating into two different solid-liquid mixtures can be useful, is sewage treatment. One example is sewage dewatering. In waste water treatment, particles are mixed with the liquid. The proportion (relative weight) of particles might be very small, but that can make removing them more difficult and/or expensive. Therefore, if the mixture can be separated into two, one with an increased or greatly increased proportion of particles and the other with a reduced proportion, subsequent treatment can be simplified. Another example is sludge removal, where removal of large particles can be useful, even if the residue includes some liquid and/or if much solid passes across the separation medium with the liquid.

Systems and methods described herein can also be used for material washing. There are many processes in which a material can be washed. It can be desirable to place the material against a separation medium and pass washing liquid (e.g., a detergent or a solvent) through the separation medium. This can be repeated without moving the material, e.g., by adding the washing liquid directly to the material to make a new mixture. Another application is oil purification/recycling, which can include removal of contaminants from oil, such as minerals and organic matter such as vegetables. Another application is pollution reduction, such as in part of a process to scrub gases, and even in the capture of gases, which can require precipitation. Other industries where solid-liquid separation can be used include, for example, ore (mineral) beneficiation, food processing, and chemical process industries.

Any of the systems and methods described herein can be used in these applications, as well as other applications known to those skilled in the art. Some embodiments herein are directed to a system for liquid desalination. These embodiments can include a separation medium adapted to separate an at least partially enclosed space into a first chamber and a second chamber, wherein the second chamber is adapted to receive salt water. These embodiments can also include a first moving element positioned in the first chamber and in contact with or substantially adjacent to the separation medium, wherein the first moving element is adapted to pull water molecules through the separation medium from the second chamber into the first chamber via one or more of surface tension, hydrodynamic, and hydrostatic forces. In some embodiments, the separation medium can be adapted to serve as a filter that reduces the salt content of salt water that passes therethrough. In some embodiments, the first moving element can be substantially impermeable to water. Those skilled in the art may appreciate that the systems for liquid desalination can include other features of the systems described herein.

Some embodiments herein are directed to methods for liquid desalination. These methods can include providing a system for liquid desalination comprising an at least partially enclosed space, a separation medium, and a first moving element, wherein: the at least partially enclosed space is divided into a first chamber and a second chamber by the separation medium, the first moving element is located in the first chamber and is in contact with or substantially adjacent to the separation medium, and the second chamber is adapted to receive a salt water mixture. These methods can further include depositing the salt water mixture to be deposited into the second chamber. These methods can further include moving the first moving element to pull at least a portion of the mixture through the separation medium from the second chamber into the first chamber, wherein a salt content of the mixture is reduced when pulling the mixture through the separation medium. In some embodiments, the first moving element, when moved can activate one or more of surface tension, hydrodynamic, and hydrostatic forces to assist in pulling the water through the separation medium. In some embodiments, the amount of salt content in water is reduced by 30%, 40%, 50%, 60%, or greater (even up to 100%).

Some embodiments herein are directed to systems for water treatment. These systems can include a separation medium adapted to separate a first chamber from a second chamber, wherein the second chamber is adapted to receive a non-potable mixture comprising a liquid. These systems can also include a first moving element positioned in the first chamber and in contact with or substantially adjacent to the separation medium, wherein the first moving element is adapted to pull the liquid through the separation medium from the second chamber into the first chamber via surface tension, hydrodynamic, or hydrostatic forces. In some embodiments, the separation medium can be adapted to serve as a filter that separates solid particles from the non-potable mixture. In other embodiments, the separation medium can be adapted to serve as a filter that separates biological organisms from the non-potable mixture. In some embodiments, the first moving element can have an outer surface that is substantially impermeable to water.

Some embodiments herein are directed to methods for water treatment. These methods can include providing a system for water treatment comprising an at least partially enclosed space, a separation medium, and a first moving element, wherein: the at least partially enclosed space can be divided into a first chamber and a second chamber by the separation medium, the first moving element can be located in the first chamber and can be in contact with or substantially adjacent to the separation medium, and the second chamber can be adapted to receive a non-potable mixture comprising a liquid. These methods can also include introducing the non-potable mixture into the second chamber. These methods can also include moving the first moving element to pull the liquid through the separation medium from the second chamber into the first chamber, wherein the liquid can be separated from the non-potable mixture upon being pulled through the separation medium. In some embodiments, moving the first moving element can activate one or more of surface tension, hydrodynamic, and hydrostatic forces to assist in pulling the liquid through the separation medium. In other embodiments, moving the first moving element to pull liquid through the separation medium can separate the liquid from solid particles in the non-potable mixture. In yet other embodiments, moving the first moving element to pull liquid through the separation medium can separate the liquid from biological organisms in the non-potable mixture.

### IV. Computer Systems

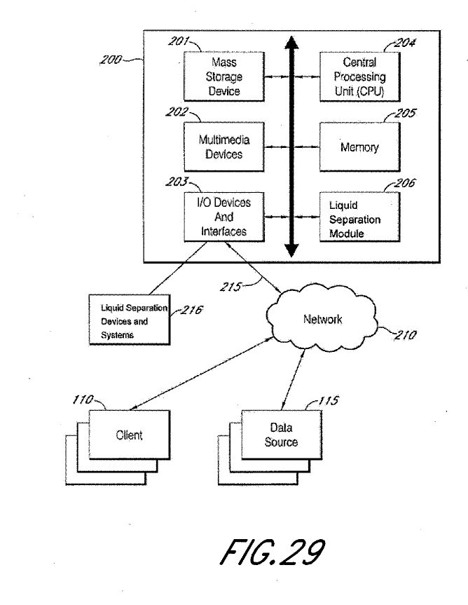

Some and/or all of the embodiments disclosed herein can be implemented in and/or are directed to systems and methods that are partially or fully automated by a computing system and/or multiple computing systems. In some embodiments, the systems, computers, and/or apparatuses described herein take the form of a computing system 200 shown in FIG. 29, which is a block diagram of one embodiment of a computing system (which can be a fixed system or mobile device) that is in communication with one or more computing systems 110 and/or one or more data sources 215 via one or more networks 210. The computing system 200 may be used to implement one or more of the systems and methods described herein, in conjunction with systems and methods commonly known to those of ordinary skill in the art. In addition, in one embodiment, the computing system 200 may be configured to perform liquid separation processes as set forth herein. While FIG. 29 illustrates one embodiment of a computing system 200, it is recognized that the functionality provided for in the components and modules of computing system 200 may be combined into fewer components and modules or further separated into additional components and modules.

### Client/Server Module

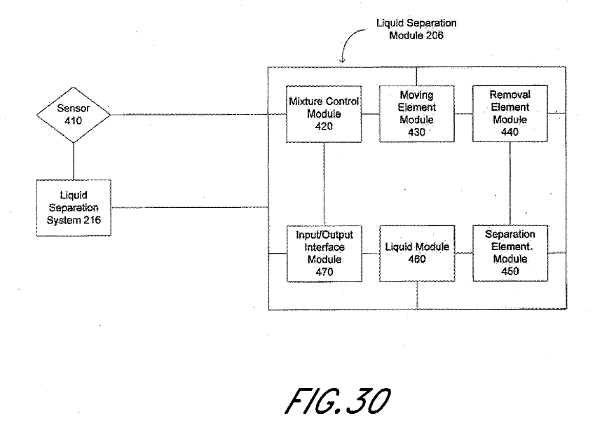

In one embodiment, the system 200 comprises a liquid separation module 206 that can carry out the functions, methods, and/or processes described herein. For example, the liquid separation module can include one or more additional modules that control the input of mixture 30, the translational movement of separation medium 2, the translational, rotational, and/or perpendicular movement of the moving elements (e.g., first moving element 4), and the translational, rotational, and/or perpendicular movement of the removal elements (e.g., removal element 20). As shown in the system diagram in FIG. 30, in some embodiments the liquid separation module 206 can include a mixture control module 420, a moving element module 430, a removal element module 440, a separation element module 450, a liquid module 460, and/or an input/output interface module 470. The mixture control module 420 can input mixture 30 into the system. In some embodiments, mixture control module 420 can be connected to sensor 410, which can monitor aspects of the mixture 30 such as concentration of residue and/or liquid 6, amount of mixture 30, pH, resistance, conductance, density, and/or moisture content. Sensor 410 can include one or more electrical and/or optical sensors, as may be known to those skilled in the art. The moving element module 430 can control the speed and/or direction of translational, rotational, and/or perpendicular movement of the moving elements (e.g., first moving element 4). The removal element module 440 can control the speed and/or direction of translational, rotational, and/or perpendicular movement of the removal elements (e.g., removal element 20). The separation element module 450 can control the speed and direction of translational, rotational, and/or perpendicular movement of the separation medium 2. In some embodiments, sensor 410 can also be connected to separation element module 450 and can determine if the separation element 2 is clogged, damaged, and/or needs to be replaced. The liquid module 460 can monitor one or more characteristics of the liquid 6 adjacent the first surface 8 of the separation medium 2, such as amount, pH, resistance, conductance, density, and/or moisture content. The input/output (I/O) interface module 470 can receive data from the I/O devices and interfaces 203, and can transmit this data to the other modules. The I/O interface module 470 can also receive data generated by the other modules and transmit this data to the I/O devices and interfaces 203. The liquid separation module 206 may be executed on the computing system 200 by a central processing unit 204 discussed further below.

### Computing System Components

In one embodiment, the processes, systems, and methods illustrated above may be embodied in part or in whole in software that is running on a computing device. The functionality provided for in the components and modules of the computing device may comprise one or more components and/or modules. For example, the computing device may comprise multiple central processing units (CPUs) and a mass storage device, such as may be implemented in an array of servers.

In general, the word “module,” as used herein, refers to logic embodied in hardware or firmware, or to a collection of software instructions, possibly having entry and exit points, written in a programming language, such as, for example, Java, C or C++, or the like. A software module may be compiled and linked into an executable program, installed in a dynamic link library, or may be written in an interpreted programming language such as, for example, BASIC, Perl, Lua, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

In one embodiment, the computing system 200 also comprises a mainframe computer suitable for controlling and/or communicating with large databases, performing high volume processing, and/or controlling multiple liquid separation devices and systems 216 and generating reports from large databases. The computing system 200 also comprises a central processing unit (“CPU”) 204, which may comprise a conventional microprocessor. The computing system 200 further comprises a memory 205, such as random access memory (“RAM”) for temporary storage of information and/or a read only memory (“ROM”) for permanent storage of information, and a mass storage device 201, such as a hard drive, diskette, or optical media storage device. Typically, the modules of the computing system 200 are connected to the computer using a standards based bus system. In different embodiments, the standards based bus system could be Peripheral Component Interconnect (PCI), Microchannel, SCSI, Industrial Standard Architecture (USA) and Extended ISA (EISA) architectures, for example.

The illustrated example of a computing system 200 comprises one or more commonly available input/output (I/O) devices and interfaces 203, such as a keyboard, mouse, touchpad, and printer. In one embodiment, the I/O devices and interfaces 203 comprise one or more display devices, such as a monitor, that allows the visual presentation of data to a user. More particularly, a display device provides for the presentation of GUIs, application software data, and multimedia presentations, for example. In the embodiment of FIG. 29, the I/O devices and interfaces 203 also provide a communications interface to various external devices. The computing system 200 may also comprise one or more multimedia devices 202, such as speakers, video cards, graphics accelerators, and microphones, for example.

### Computing System Device/Operating System

The computing system 200 may run on a variety of computing devices, such as, for example, a server, a Windows server, a Structure Query Language server, a Unix server, a personal computer, a mainframe computer, a laptop computer, a cell phone, a personal digital assistant, a kiosk, an audio player, and so forth. The computing system 200 is generally controlled and coordinated by operating system software, such as z/OS, Windows 95, Windows 98, Windows NT, Windows 2000, Windows XP, Windows Vista, Linux, BSD, SunOS, Solaris, or other compatible operating systems. In Macintosh systems, the operating system may be any available operating system, such as MAC OS X. In other embodiments, the computing system 200 may be controlled by a proprietary operating system. Conventional operating systems control and schedule computer processes for execution, perform memory management, provide file system, networking, and I/O services, and provide a user interface, such as a graphical user interface (“GUI”), among other things.

### Network

In the embodiment of FIG. 29, the computing system 200 is coupled to a network 210, such as a LAN, WAN, or the Internet, for example, via a wired, wireless, or combination of wired and wireless, communication link 215. The network 210 communicates with various computing devices and/or other electronic devices via wired or wireless communication links. In the representative embodiment of FIG. 29, the network 210 is communicating with one or more computing systems 217 and/or one or more data sources 219.

Access to the liquid separation module 206 of the computer system 200 by client systems 110 and/or by data sources 115 may be through a web-enabled user access point such as the computing systems 110 or data sources 115 personal computer, cellular phone, laptop, or other device capable of connecting to the network 210. Such a device may have a browser module is implemented as a module that uses text, graphics, audio, video, and other media to present data and to allow interaction with data via the network 210.

The browser module or other output module may be implemented as a combination of an all points addressable display such as a cathode-ray tube (CRT), a liquid crystal display (LCD), a plasma display, or other types and/or combinations of displays. In addition, the browser module or other output module may be implemented to communicate with input devices 203 and may also comprise software with the appropriate interfaces which allow a user to access data through the use of stylized screen elements such as, for example, menus, windows, dialog boxes, toolbars, and controls (for example, radio buttons, check boxes, sliding scales, and so forth). Furthermore, the browser module or other output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition a touch screen may act as a hybrid input/output device. In another embodiment, a user may interact with the system more directly such as through a system terminal connected to the score generator without communications over the Internet, a WAN, or LAN, or similar network.

In some embodiments, the system 200 may comprise a physical or logical connection established between a remote microprocessor and a mainframe host computer for the express purpose of uploading, downloading, or viewing interactive data and databases on-line in real time. The remote microprocessor may be operated by an entity operating the computer system 200, including the client server systems or the main server system, an/or may be operated by one or more of the data sources 115 and/or one or more of the computing systems. In some embodiments, terminal emulation software may be used on the microprocessor for participating in the micro-mainframe link.

In some embodiments, client systems 110 who are internal to an entity operating the computer system 200 may access the liquid separation module 206 internally as an application or process run by the CPU 204.

### User Access Point

In one embodiment, a user access point comprises a personal computer, a laptop computer, a cellular phone, a GPS system, a Blackberry® device, a portable computing device, a server, a computer workstation, a local area network of individual computers, an interactive kiosk, a personal digital assistant, an interactive wireless communications device, a handheld computer, an embedded computing device, or the like.

### Other Systems

In addition to the systems that are illustrated in FIG. 29, the network 210 may communicate with other data sources or other computing devices. The computing system 200 may also comprise one or more internal and/or external data sources. In some embodiments, one or more of the data repositories and the data sources may be implemented using a relational database, such as DB2, Sybase, Oracle, CodeBase and Microsoft® SQL Server as well as other types of databases such as, for example, a flat file database, an entity-relationship database, and object-oriented database, and/or a record-based database.

The liquid separation devices and systems 216 can comprise without limitation, for example, a separation medium assembly, a moving element assembly, and any other hardware component for performing the liquid separation process disclosed herein.

In some embodiments, the acts, methods, method steps, and processes described herein are implemented within, or using, software modules (programs) that are executed by one or more general purpose computers and/or computer systems. The software modules may be stored on or within any suitable computer-readable medium. It should be understood that the various steps may alternatively be implemented in-whole or in-part within specially designed hardware. The skilled artisan will recognize that not all calculations, analyses and/or optimization require the use of computers, though any of the above-described methods, calculations or analyses can be facilitated through the use of computers.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Additionally, the skilled artisan will recognize that any of the above-described methods can be carried out using any appropriate apparatus. Further, the disclosure herein of any particular feature, aspect, method, property, characteristic, quality, attribute, element, or the like in connection with an embodiment can be used in all other embodiments set forth herein. Thus, it is intended that the scope of the present invention herein disclosed should not be limited by the particular disclosed embodiments described above.

What is claimed is:

1. A system for liquid separation, comprising:
a separation medium adapted to separate a liquid from a mixture, the separation medium having a first surface and a second surface, wherein the second surface is opposite the first surface and the second surface is adapted to contact the mixture; and
a first moving element having an outer surface, wherein:
at least a portion of the outer surface is movable relative to the separation medium,
the first moving element is adapted to urge the liquid through the separation medium from the second surface to the first surface, and
the outer surface of the first moving element is located in contact with or substantially adjacent to the first surface relative to the second surface.

2. The system of claim 1, wherein the outer surface of the first moving element contacts the first surface of the separation medium.

3. The system of claim 1, wherein the outer surface of the first moving element does not contact the separation medium.

4. The system of claim 1, wherein in at least one configuration the outer surface of the first moving element is separated from the separation medium by a distance such that the at least a portion of the outer surface of the first moving element, when moved relative to the separation medium, is adapted to generate at least one of surface tension, hydrodynamic, and hydrostatic forces between the first moving element and the liquid.

5. The system of claim 1, wherein the first moving element is adapted for upward and downward movement relative to the separation medium.

6. The system of claim 1, wherein the first moving element is a roller adapted to rotate about a first axis which generally lies parallel to the first surface of the separation medium.

7. The system of claim 1, wherein the outer surface of the first moving element is substantially rigid.

8. The system of claim 1, further comprising a second moving element positioned adjacent to the first moving element, wherein the second moving element is in fluid communication with the first surface of the separation medium.

9. The system of claim 1, further comprising a removal element located in close contact with or in proximity to the first moving element, wherein the removal element is adapted to remove at least some of the liquid from the first moving element.

10. The system of claim 9, further comprising a second moving element, wherein the second moving element does not contact the removal element and is adapted to maintain the presence of liquid on the first surface of the separation medium.

11. A method for liquid separation, comprising:
moving at least a portion of an outer surface of a first moving element into contact with or substantially adjacent to a first surface of a separation medium, the separation medium further comprising a second surface opposite the first surface, the second surface in contact with a mixture comprising a liquid, wherein the movement urges a first amount of liquid to move through the separation medium from the second surface to the first surface to contact the outer surface of the first moving element; and
moving the portion of the outer surface of the first moving element away from the first surface to cause the first amount of liquid to be removed from the separation medium.

12. The method of claim 11, wherein moving at least a portion of the outer surface of the first moving element towards and away from the first surface increases the flow of the liquid through the separation medium as compared to the flow of the liquid in the absence of the first moving element.

13. The method of claim 11, further comprising removing at least some of the first amount of the liquid from the outer surface of the first moving element by contacting the outer surface of the first moving element with a removal element.

14. The method of claim 11, further comprising:
translating at least a portion of the separation medium away from the first moving element and towards a second moving element;
moving at least a portion of an outer surface of the second moving element into contact with or substantially adjacent to the first surface of a separation medium, wherein the movement urges a second amount of liquid to move through the separation medium from the second surface to the first surface to contact the outer surface of the second moving element; and
moving the at least a portion of the outer surface of the second moving element away from the first surface to cause the second amount of liquid to be removed from the separation medium.

15. The method of claim 51, further comprising:
causing a second amount of liquid to be moved through the separation medium from the second surface to the first surface by moving at least a second portion of the outer surface of the first moving element into contact with or substantially adjacent to the first surface;
causing the second amount of liquid to be removed from the separation medium by moving the second portion of the first moving element away from and out of fluid communication with the first surface; and
moving the second portion of the outer surface of the first moving element away from the first surface to remove the second amount of liquid from the separation medium.

16. The method of claim 11, further comprising unclogging the separation medium, comprising:
moving a second amount of liquid through the separation medium from the second surface to the first surface by moving at least a portion of an outer surface of a second moving element into contact with or substantially adjacent to the first surface;
removing the second amount of liquid from the separation medium by moving the portion of the second moving element away from the first surface; and
moving at least a portion of the second amount of liquid back through the separation medium from the first surface to the second surface by moving the portion of the second moving element to be placed into contact with or adjacent to the first surface to unclog the separation medium.

17. The method of claim 11, further comprising establishing a liquid coating on the separation medium, comprising:
moving a second amount of liquid through the separation medium from the second surface to the first surface by placing at least a portion of an outer surface of a second moving element in contact with or substantially adjacent to the first surface;
removing the second amount of liquid from the separation medium by moving the portion of the second moving element away from the first surface; and
applying at least a portion of the second amount of liquid to the first surface by placing the portion of the second moving element into contact with or substantially adjacent to the first surface.

18. A system for liquid desalination, comprising:
a separation medium adapted to separate an at least partially enclosed space into a first chamber and a second chamber, wherein the second chamber is adapted to receive salt water; and
a first moving element positioned in the first chamber and in contact with or substantially adjacent to the separation medium, wherein the first moving element is adapted to pull water molecules through the separation medium from the second chamber into the first chamber via one or more of surface tension, hydrodynamic, and hydrostatic forces.

19. The system of claim 18, wherein the separation medium is adapted to serve as a filter that reduces the salt content of salt water.

20. The system of claim 18, wherein the first moving element is substantially impermeable to water.
